(19) United States
(12) Patent Application Publication
(10) Pub. No.: US 2018/0211001 A1
(43) Pub. Date: Jul. 26, 2018

(54) TRACE RECONSTRUCTION FROM NOISY POLYNUCLEOTIDE SEQUENCER READS

(71) Applicant: Microsoft Technology Licensing, LLC, Redmond, WA (US)

(72) Inventors: Parikshit S. Gopalan, Palo Alto, CA (US); Sergey Yekhanin, Redmond, WA (US); Siena Dumas Ang, Seattle, WA (US); Nebojsa Jojic, Redmond, WA (US); Miklos Racz, Seattle, WA (US); Karen Strauss, Seattle, WA (US); Luis Ceze, Redmond, WA (US)

(73) Assignee: Microsoft Technology Licensing, LLC, Redmond, WA (US)

(21) Appl. No.: 15/536,115

(22) PCT Filed: Apr. 25, 2017
(86) PCT No.: PCT/US2017/029230

§ 371 Date: Jun. 14, 2017

Related U.S. Application Data
(60) Provisional application No. 62/329,945, filed on Apr. 29, 2016.

(51) Int. Cl. G06F 19/22; G06F 11/34; G06F 19/24; G06F 19/16

(52) U.S. Cl. CPC G06F 19/22; G06F 11/3466; G06F 2201/81; G06F 19/16; G06F 19/24

(57) ABSTRACT

Polynucleotide sequencing generates multiple reads of a polynucleotide molecule. Many or all of the reads may contain errors. Trace reconstruction takes multiple reads generated by a polynucleotide sequencer and uses those multiple reads to reconstruct accurately the nucleotide sequence. The types of errors are substitutions, deletions, and insertions. The location of an error in a read is identified by comparing the sequence of the read to the other reads. The type of error is determined by comparing both the base call of the read at the error location and base calls of the read and other reads in a look-ahead window that includes base calls adjacent to the error location. A consensus output sequence is developed from the sequences of the multiple reads and identification of the error types for errors in the reads.

### CROSS-REFERENCE TO RELATED APPLICATION

This is a national stage application of international patent application No. PCT/US2017/029230 entitled “Trace Reconstruction From Noisy Polynucleotide Sequencer Reads,” and filed Apr. 25, 2017, which claims priority to U.S. Provisional Patent Application Ser. No. 62/329,945 filed on Apr. 29, 2016, entitled “Trace Reconstruction from Noisy Polynucleotide Sequencer Reads.” PCT International Application No. PCT/US2017/029230 and U.S. Provisional Application Ser. No. 62/329,945 are fully incorporated herein by reference in their entirety.

### BACKGROUND

Much of the world's data today is stored on magnetic and optical media. Tape technology has recently seen significant density improvements with single tape cartridges storing 185 TB, and is the densest form of storage available commercially today, at about 10 GB/mm³. Recent research reported feasibility of optical discs capable of storing 1PB, yielding a density of about 100 GB/mm³. Despite this improvement, storing a zettabyte (2⁷⁰ bytes or a billion terabytes) of data would still take many millions of units, and use significant physical space. But storage density is only one aspect of storage media; durability is also important. Rotating disks are rated for 3-5 years, and tape is rated for 10-30 years. Long-term archival storage requires data refreshes, both to replace faulty units and to refresh technology.

Demand for data storage is growing exponentially, but the capacity of existing storage media is not keeping up. Polymers of deoxyribose nucleic acid (DNA) are capable of storing information at high density. The theoretical density limit is 1 exabyte/mm³ (10⁹ GB/mm³). Less than 100 grams of DNA could store all the human-made data in the world today. DNA is also long lasting, with an observed half-life of over 500 years under certain storage conditions. Thus, DNA is appealing as an information storage technology because of its high information density and longevity. A further advantage of DNA as a storage media is its continued relevance. Operating systems and standards for storage media will change potentially making data on older storage systems inaccessible. But DNA-based storage has the benefit of eternal relevance: as long as there is DNA-based life, there will be strong reasons to maintain technology that is able to read and manipulate DNA.

Although it has advantages, a DNA storage system must overcome several challenges. For example, DNA synthesis, degradation during storage, and sequencing are all potential sources of errors. Thus, a DNA sequence output by a sequencer may be different from the DNA sequence originally provided to an oligonucleotide synthesizer.

### SUMMARY

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

Binary data of the kind currently used by computers to store text files, audio files, video files, software and the like can be represented as a series of nucleic acids in a polynucleotide (i.e., DNA or RNA). There are multiple techniques for representing the 0 and 1 of binary data as a series of nucleotides. These techniques are known to persons of ordinary skill in the art and examples of some simple techniques provided in provisional U.S. patent application No. 62/255,269. Once a polynucleotide is placed into storage, it is ultimately read out of storage by sequencing. Machines that read the sequences of polynucleotides, sequencers, are not 100% accurate and introduce errors. This disclosure provides techniques for correcting errors in sequence data generated by polynucleotide sequencers.

Some polynucleotide sequencing technology generates multiple reads of a polynucleotide strand. Each of the reads may have a slightly different sequence but all of the reads are classified as representing the same DNA strand. Analysis includes identifying a position of comparison spanning the multiple reads. In some implementations, the position of comparison may start as the first position in each of the multiple reads. A plurality consensus base call is determined at the position of comparison. The plurality consensus base call is the most frequent base call across all of the multiple reads at the position of comparison. One or more variant reads are identified that have a base call in the position of comparison that differs from the plurality consensus base call. An error type is determined for the variant reads by comparing a consensus string of base calls adjacent to the position of comparison in the reads that are not variant reads with base calls in the variant read. The error type may be a substitution, a deletion, or an insertion.

After a given position of comparison is analyzed, the position of comparison is moved for further analysis. The position of comparison may be moved different amounts for different ones of the multiple reads. For the variant reads, the position of comparison may be moved a number of positions that varies based on the type of error. For the reads that are not variant reads, the position of comparison is advanced one base to the next position along the reads. Ultimately, a single consensus output sequence is determined from the plurality of reads and from the identified error types. The consensus output sequence is more likely to represent the actual sequence of nucleotides in the source DNA strand than any of the multiple reads.

### DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows an illustrative architecture for operation of a trace reconstruction system.

FIG. 2 is an illustrative schematic showing use of a trace reconstruction system.

FIG. 3 shows an illustrative representation of a substitution error identified according to the techniques of this disclosure.

FIG. 4 shows illustrative representation of a deletion error identified according to the techniques of this disclosure.

FIG. 5 shows an illustrative representation of an insertion error identified according to the techniques of this disclosure.

FIG. 6 shows a block diagram of an illustrative trace reconstruction system.

FIGS. 7A and 7B show an illustrative process for determining a consensus output sequence from a plurality of reads.

FIGS. 8A and 8B show an illustrative process for generating binary data from reads received from a polynucleotide sequencer.

FIG. 9 is a graph showing how the probability of exactly reconstructing the sequence of bases on a DNA strand changes as the error percentage in reads of the DNA strand changes. This graph compares the effects of varying a look-ahead window size and of different distributions of error types.

FIG. 10 is a graph showing how the probability of exactly reconstructing the sequence of bases on a DNA strand changes as the error percentage in reads of the DNA strand changes. This figure compares the technique of this disclosure with alternative techniques.

### DETAILED DESCRIPTION

As mentioned above, DNA has great potential as a storage media for digital information. However, dealing with errors that may corrupt the data is one of the challenges of using DNA to store digital data. There are many steps involved in converting digital data into a synthetic DNA molecule and then recovering the digital data from the synthetic DNA molecule. The techniques described in this disclosure provide error correction for the step of sequencing DNA strands to recover the digital data. The term “DNA strands,” or simply “strands,” refers to DNA molecules. Current DNA sequencing technology does not provide 100% accurate reads of the DNA molecules. As used herein, “read” may be a noun that refers to a string of data generated by a polynucleotide sequencer when the polynucleotide sequencer reads the sequence of a DNA strand. However, reads produced by polynucleotide sequencers frequently contain errors, and thus, do not represent the structure of DNA strands with 100% accuracy. However, many DNA sequencing technologies produce multiple reads of a DNA strand. The reads are referred to as “noisy reads” because each likely contains one or more errors that have a distribution that is approximately random. Although a given read may also be error free. The techniques of this disclosure use the multiplicity of different noisy reads for a single DNA strand to create a consensus output sequence that is likely to represent the true sequence of the DNA strand. The consensus output sequence is a string of data similar to any of the reads, but the consensus output sequence is generated from analysis of the reads rather than being output directly from a polynucleotide sequencer. The process of going from many noisy reads to one, presumably accurate, consensus output sequence is referred to as “trace reconstruction.”

Naturally occurring DNA strands consist of four types of nucleotides: adenine (A), cytosine (C), guanine (G), and thymine (T). A DNA strand, or polynucleotide, is a linear sequence of these nucleotides. The two ends of a DNA strand, referred to as the 5′ and 3′ ends, are chemically different. DNA sequences are conventionally represented starting with the 5′ nucleotide end. The interactions between different strands are predictable based on sequence: two single strands can bind to each other and form a double helix if they are complementary: A in one strand aligns with T in the other, and likewise for C and G. The two strands in a double helix have opposite directionality (5′ end attached to the other strand's 3′ end), and thus the two sequences are the “reverse complement” of each other. Two strands do not need to be fully complementary to bind to one another. Ribonucleic acid (RNA) has a similar structure to DNA and naturally occurring RNA consists of the four nucleotides A, C, G, and uracil (U) instead of T. Discussions in this disclosure mention only DNA for the sake of brevity and readability, but RNA may be used in place of or in combination with DNA.

The trace reconstruction problem may be set out using mathematical notation as follows. Let Σ denote a finite alphabet, for instance Σ={A, C, G, T}. Let X∈Σⁿ be a sequence of interest, which can be arbitrary or random. The goal is to reconstruct the sequence of the DNA strand X exactly from a collection of noisy reads in which the noise is distributed independent at least to a degree. In synthetic test data, the noise can be independent and identically distributed (i.i.d.) throughout the strands. Stated differently, let Y₁, Y₂, . . . , Yₘ be i.i.d. sequences obtained from X in the following way. Let p_{d}, pᵢ, and pₛ denote deletion, insertion, and substitution probabilities, respectively, such that p=p_{d}+pᵢ+pₛ∈[0, 1]. To obtain a noisy read Y, start with an empty string, and for a position of comparison j=1, 2, . . . , n, do the following:

(no error) with probability 1−p, copy X[j] to the end of Y and increase j by 1;

(deletion) with probability p_{d}, increase j by 1;

(insertion) with probability pᵢ, copy X[j] to the end of Y, add a random symbol at the end of Y, and increase j by 1;

(substitution) with probability pₛ, add a random symbol at the end of Y and increase j by 1.

A trace reconstruction system outputs an estimate \hat{X}=\hat{X}(Y₁, Y₂, . . . , Yₘ). The goal is to exactly reconstruct X, i.e., to minimize instances in which [symbol] (\hat{X}≠X). Other related noise models can be considered as well, such as allowing multiple insertions at a step. For the sake of brevity, discussions in this disclosure focus on the noise model described above, but the applicability of the trace reconstruction system is not limited to this setting.

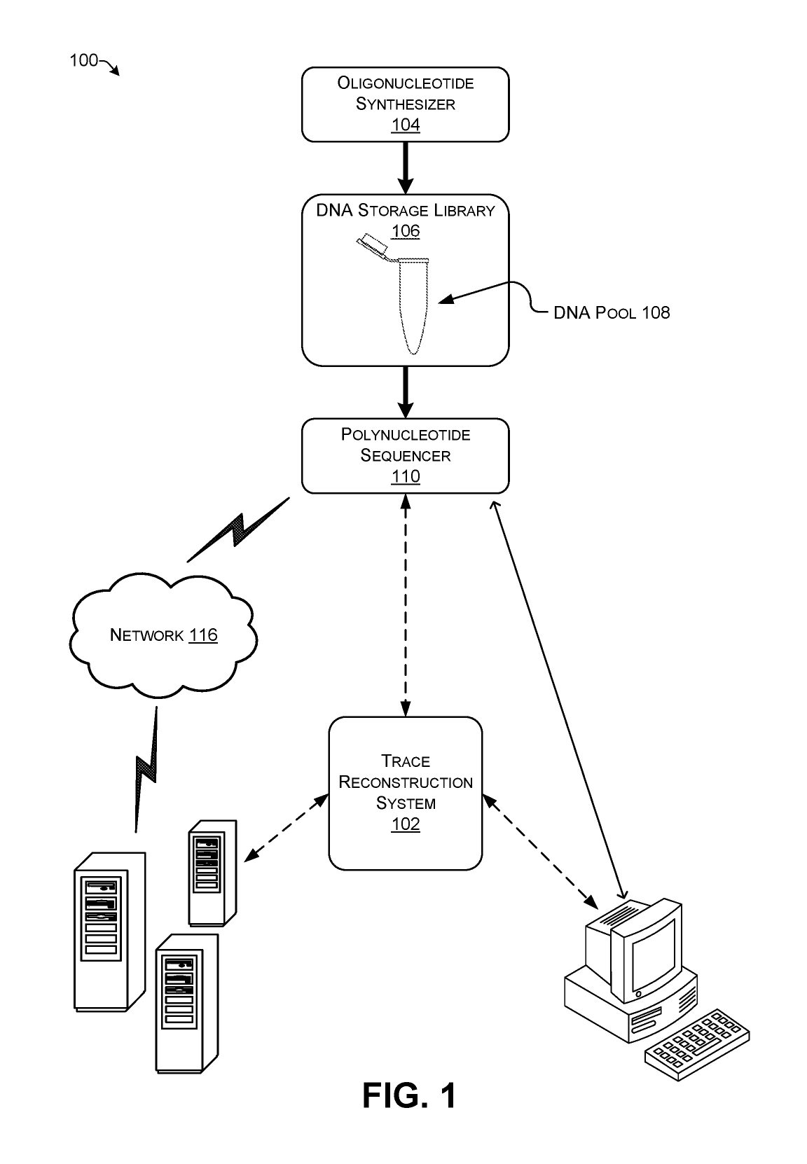

FIG. 1 shows an illustrative architecture 100 for implementing a trace reconstruction system 102. Briefly, digital information that is intended for storage as DNA molecules is converted into information representing a string of nucleotides. The information representing the string of nucleotides (i.e., a string of letters representing an order of nucleotide bases) is used as DNA-synthesis templates that instruct an oligonucleotide synthesizer 104 to chemically synthesize a DNA molecule nucleotide by nucleotide. Artificial synthesis of DNA allows for creation of synthetic DNA molecules with arbitrary series of the bases in which individual monomers of the bases are assembled together into a polymer of nucleotides. The oligonucleotide synthesizer 104 may be any oligonucleotide synthesizer using any recognized technique for DNA synthesis. The term “oligonucleotide” as used herein is defined as a molecule including two or more nucleotides.

The coupling efficiency of a synthesis process is the probability that a nucleotide binds to an existing partial strand at each step of the process. Although the coupling efficiency for each step can be higher than 99%, this small error still results in an exponential decrease of product yield with increasing length and limits the size of oligonucleotides that can be efficiently synthesized at present to about 200 nucleotides. Therefore, the length of DNA strands put into storage is around 100 to 200 base pairs. This length will increase with advances in oligonucleotide synthesis technology.

The synthetic DNA produced by the oligonucleotide synthesizer 104 may be transferred to a DNA storage library 106. There are many possible ways to structure a DNA storage library 106. In addition to structure on the molecular level by appending identifying sequences, or other techniques, to the DNA strands, a DNA storage library 106 may be structured by physically separating DNA strands into one or more DNA pools 108. Here the DNA pool 108 is shown as a flip top tube representing a physical container for multiple DNA strands. DNA strands are generally most accessible for manipulation by bio-technological techniques when the DNA is stored in a liquid solution. Thus, the DNA pool 108 can be implemented as a chamber filled with liquid, in many implementations water, and thousands, millions, or more individual DNA molecules may be present in a DNA pool 108.

Besides being in a liquid suspension, the DNA strands in the DNA storage library 106 may be present in a glassy (or vitreous) state, as lyophilized product, or other format. The structure of the DNA pools 108 may be implemented as any type of mechanical, biological, or chemical arrangement that holds a volume of liquid including DNA to a physical location. Storage may also be in a non-liquid form such as a solid bead or by encapsulation. For example, a single flat surface having a droplet present thereon, with the droplet held in part by surface tension of the liquid, even though not fully enclosed within a container, is one implementation of a DNA pool 108. The DNA pool 108 may include single-stranded DNA (ssDNA), double-stranded DNA (dsDNA), single-stranded RNA (ssRNA), double-stranded RNA (dsRNA), DNA-RNA hybrid strands, or any combination including use of unnatural bases.

DNA strands removed from the DNA storage library 106 may be sequenced with a polynucleotide sequencer 110. In some implementations, DNA strands may be prepared for sequencing by amplification using polymerize chain reaction (PCR) to create a large number of DNA strands that are identical copies of each other. The need for PCR amplification prior to sequencing may depend on the specific sequencing technology used. PCR may itself be a source of error, although at a much lower level than current sequencing technology. At present, PCR techniques typically introduce one error per 10,000 bases. Thus, on average, for every 100 reads of 100 bases there will be one error that is the result of PCR. The errors introduced by PCR are generally distributed randomly so the trace reconstruction system will be able to correct some PCR-induced errors.

As mentioned above, the polynucleotide sequencer 110 reads the order of nucleotide bases in a DNA strand and generates one or more reads from that strand. Polynucleotide sequencers 110 use a variety of techniques to interpret molecular information, and may introduce errors into the data in both systematic and random ways. Errors can usually be categorized as substitution errors, where the real code is substituted with an incorrect code (for example A swapping with G), insertions, or deletions, where a random unit is inserted (for example AGT becoming AGCT) or deleted (for example AGTA becoming ATA). Each position in a read is an individual base call determined by the polynucleotide sequencer 110 based on properties sensed by components of the polynucleotide sequencer 110. The various properties sensed by the polynucleotide sequencer 110 vary depending on the specific sequencing technology used. A base call represents a determination of which of the four nucleotide bases—A, G, C, and T (or U)—in a strand of DNA (or RNA) is present at a given position in the strand. Sometimes the base calls are wrong and this is a source of error introduced by sequencing. Polynucleotide sequencing includes any method or technology that is used to generate base calls from a strand of DNA or RNA.

A sequencing technology that can be used is sequencing-by-synthesis (Illumina® sequencing). Sequencing by synthesis is based on amplification of DNA on a solid surface using fold-back PCR and anchored primers. The DNA is fragmented, and adapters are added to the 5′ and 3′ ends of the fragments. DNA fragments that are attached to the surface of flow cell channels are extended and bridge amplified. The fragments become double stranded, and the double stranded molecules are denatured. Multiple cycles of the solid-phase amplification followed by denaturation can create several million clusters of approximately 1,000 copies of single-stranded DNA molecules of the same template in each channel of the flow cell. Primers, DNA polymerase, and four fluorophore-labeled, reversibly terminating nucleotides are used to perform sequential sequencing. After nucleotide incorporation, a laser is used to excite the fluorophores, and an image is captured and the identity of the first base is recorded. The 3′ terminators and fluorophores from each incorporated base are removed and the incorporation, detection, and identification steps are repeated.

Another example of a sequencing technique that can be used is nanopore sequencing. A nanopore is a small hole of the order of 1 nanometer in diameter. Immersion of a nanopore in a conducting fluid and application of a potential across the nanopore results in a slight electrical current due to conduction of ions through the nanopore. The amount of current that flows through the nanopore is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore represents a reading of the DNA sequence.

Another example of a sequencing technology that can be used includes the single molecule, real-time (SMRT™) technology of Pacific Biosciences. In SMRT™, each of the four DNA bases is attached to one of four different fluorescent dyes. These dyes are phospholinked. A single DNA polymerase is immobilized with a single molecule of template single stranded DNA at the bottom of a zero-mode waveguide (ZMW). A ZMW is a confinement structure that enables observation of incorporation of a single nucleotide by DNA polymerase against the background of fluorescent nucleotides that rapidly diffuse in and out of the ZMW (in microseconds). It takes several milliseconds to incorporate a nucleotide into a growing strand. During this time, the fluorescent label is excited and produces a fluorescent signal, and the fluorescent tag is cleaved off. Detection of the corresponding fluorescence of the dye indicates which base was incorporated. The process is repeated.

Another sequencing technique that can be used is Helicos True Single Molecule Sequencing (tSMS). In the tSMS technique, a DNA sample is cleaved into strands of approximately 100 to 200 nucleotides, and a polyA sequence is added to the 3′ end of each DNA strand. Each strand is labeled by the addition of a fluorescently labeled adenosine nucleotide. The DNA strands are then hybridized to a flow cell, which contains millions of oligo-T capture sites that are immobilized to the flow cell surface. The templates can be at a density of about 100 million templates/cm². The flow cell is then loaded into an instrument, e.g., a HeliScope™ sequencer, and a laser illuminates the surface of the flow cell, revealing the position of each template. A CCD camera can map the position of the templates on the flow cell surface. The template fluorescent-label is then cleaved and washed away. The sequencing reaction begins by introducing a DNA polymerase and a fluorescently-labeled nucleotide. The oligo-T nucleic acid serves as a primer. The polymerase incorporates the labeled nucleotides to the primer in a template-directed manner. The polymerase and unincorporated nucleotides are removed. The templates that have directed incorporation of the fluorescently labeled nucleotide are detected by imaging the flow cell surface. After imaging, a cleavage step removes the fluorescent label, and the process is repeated with other fluorescently-labeled nucleotides until the desired read length is achieved. Sequence information is collected with each nucleotide addition step.

Another example of a DNA sequencing technique that can be used is SOLiD™ technology (Applied Biosystems). In SOLiD™ sequencing, DNA is sheared into fragments, and adaptors are attached to the 5′ and 3′ ends of the fragments to generate a fragment library. Alternatively, internal adaptors can be introduced by ligating adaptors to the 5′ and 3′ ends of the fragments, circularizing the fragments, digesting the circularized fragment to generate an internal adaptor, and attaching adaptors to the 5′ and 3′ ends of the resulting fragments to generate a mate-paired library. Next, clonal bead populations are prepared in microreactors containing beads, primers, templates, and PCR components. Following PCR, the templates are denatured and beads are enriched to separate the beads with extended templates. Templates on the selected beads are subjected to a 3′ modification that permits bonding to a glass slide.

Another example of a sequencing technique that can be used involves using a chemical-sensitive field effect transistor (chemFET) array to sequence DNA. In one example of the technique, DNA molecules can be placed into reaction chambers, and the template molecules can be hybridized to a sequencing primer bound to a polymerase. Incorporation of one or more triphosphates into a new nucleic acid strand at the 3′ end of the sequencing primer can be detected by a change in current by a chemFET. An array can have multiple chemFET sensors. In another example, single nucleic acids can be attached to beads, and the nucleic acids can be amplified on the bead, and the individual beads can be transferred to individual reaction chambers on a chemFET array, with each chamber having a chemFET sensor, and the nucleic acids can be sequenced.

Another example of a sequencing technique that can be used involves using an electron microscope. In one example of the technique, individual DNA molecules are labeled using metallic labels that are distinguishable using an electron microscope. These molecules are then stretched on a flat surface and imaged using an electron microscope to measure sequences.

All technologies for sequencing DNA are associated with some level of error and the type and frequency of errors differs by sequencing technology. For example, sequencing-by-synthesis creates an error in about 2% of the base calls. A majority of these errors are substitution errors. Nanopore sequencing has a much higher error rate of about 15 to 40% and most of the errors caused by this sequencing technology are deletions. The error profile of a specific sequencing technology may describe the overall frequency of errors as well as the relative frequency of various types of errors.

In some implementations, the polynucleotide sequencer 110 provides quality information that indicates a level of confidence in the accuracy of a given base call. The quality information may indicate that there is a high level or a low level of confidence in a particular base call. For example, the quality information may be represented as a percentage, such as 80% confidence, in the accuracy of a base call. Additionally, quality information may be represented as a level of confidence that each of the four bases is the correct base call for a given position in a DNA strand. For example, quality information may indicate that there is 80% confidence the base call is a T, 18% confidence the base call is an A, 1% confidence the base call is a G, and 1% confidence the base call is a C. Thus, the result of this base call would be T because there is higher confidence in that nucleotide being the correct base call than in any of the other nucleotides. Quality information does not identify the source of an error, but merely suggests which base calls are more or less likely to be accurate.

The polynucleotide sequencer 110 provides output, multiple noisy reads (possibly of multiple DNA strands), in electronic format to the trace reconstruction system 102. The output may include the quality information as metadata for otherwise associated with the reads produced by the polynucleotide sequencer 110.

The trace reconstruction system 102 may be implemented as an integral part of the polynucleotide sequencer 110. The polynucleotide sequencer 110 may include an onboard computer that implements the trace reconstruction system 102. Alternatively, the trace reconstruction system 102 may be implemented as part of a separate computing device 112 that is directly connected to the polynucleotide sequencer 110 through a wired or wireless connection which does not cross a network. For example, the computing device 112 may be a desktop or notebook computer used to receive data from and/or to control the polynucleotide sequencer 110. A wired connection may include one or more wires or cables physically connecting the computing device 112 to the polynucleotide sequencer 110. The wired connection may be created by a headphone cable, a telephone cable, a SCSI cable, a USB cable, an Ethernet cable, FireWire, or the like. The wireless connection may be created by radio waves (e.g., any version of Bluetooth, ANT, Wi-Fi IEEE 802.11, etc.), infrared light, or the like. The trace reconstruction system 102 may also be implemented as part of a cloud-based or network system using one or more servers 114 that communicate with the polynucleotide sequencer 110 via a network 116. The network 116 may be implemented as any type of communications network such as a local area network, a wide area network, a mesh network, an ad hoc network, a peer-to-peer network, the Internet, a cable network, a telephone network, and the like. Additionally, the trace reconstruction system 102 may be implemented in part by any combination of the polynucleotide sequencer 110, the computing device 112, and the servers 114.

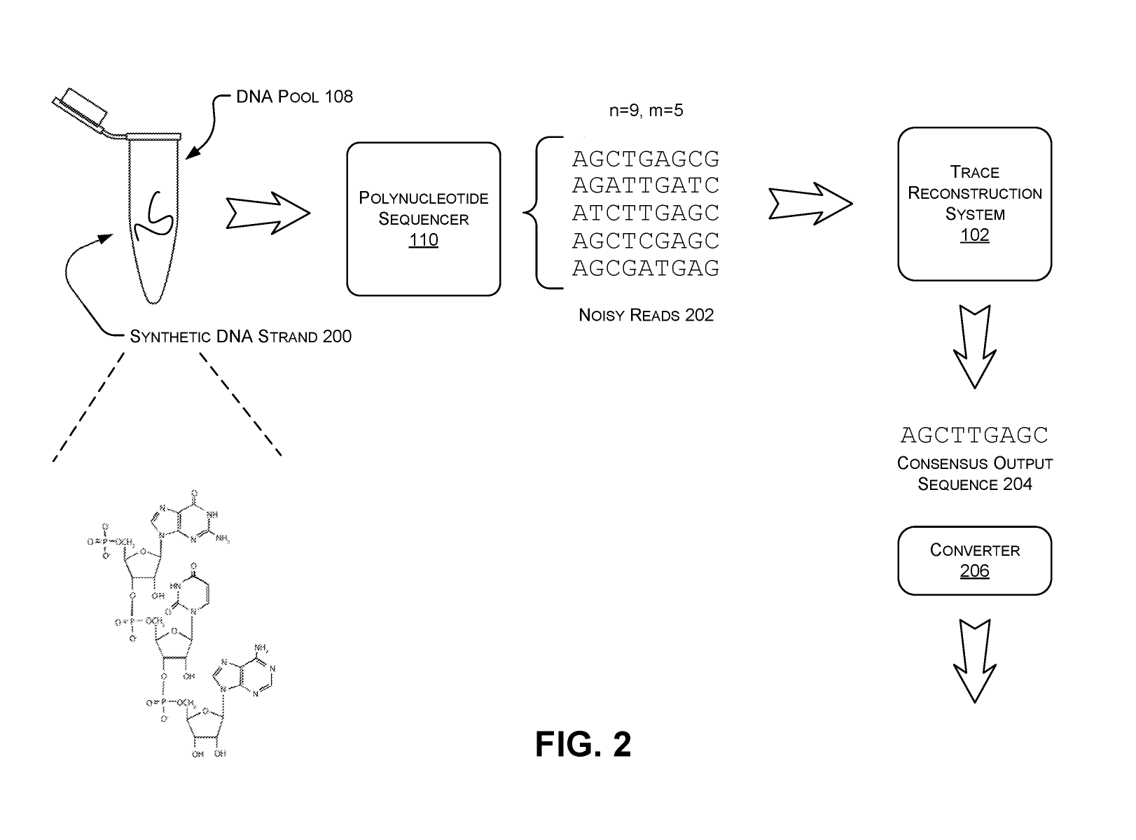

FIG. 2 shows use of the trace reconstruction system 102 as part of the process of decoding information stored in a synthetic DNA strand 200. The synthetic DNA strand 200 is a molecule having a specific sequence of nucleotide bases. The synthetic DNA strand 200 may be stored in a DNA pool 108 as shown in FIG. 1. The synthetic DNA strand 200 may be present in the DNA pool 108 as a single-stranded molecule or may hybridize to a complementary ssDNA molecule to form dsDNA. The polynucleotide sequencer 110 produces an output of multiple noisy reads 202 from the single synthetic DNA strand 200. Each of the reads has a length (n) which in this example is nine corresponding to nine bases in the synthetic DNA strand 200. In actual sequencer data the noisy reads may have arbitrary lengths that are not all equal to each other. Deletions and insertions are one cause of variation in read length. For a given read, that read's length may be denoted as n, but n is not necessarily the same for all reads. In actual implementations, the length of the reads is likely to be between 100 and 200 due to current limitations on the maximum length of DNA strands that can be artificially synthesized. Locations on a read may be referred to as “positions” such as in this example going from position one to position nine. As used herein, “base” refers to a location of a given monomer in a DNA molecule while “position” refers to a location along a string of data such as a read. Thus, assuming no errors, the third base in the synthetic DNA strand 200 corresponds to the third position in a read generated by the polynucleotide sequencer 110.

The number (m) of noisy reads 202 provided to the trace reconstruction system 102 is five in this example. However, any number may be used. In some implementations, the number of noisy reads 202 provided to the trace reconstruction system 102 may be 10, 20, or 100. The number of noisy reads 202 provided to the trace reconstruction system 102 may be less than total number of reads produced by the polynucleotide sequencer 110. A subset of the total number reads produced by the polynucleotide sequencer 110 may be selected at random or using heuristics for analysis by the trace reconstruction system 102. In addition to random selection, other techniques may be used for choosing which subset of reads are passed to the trace reconstruction system 102. For example, quality information may be used to identify m reads having the highest confidence in the base calls from all of the reads generated by the polynucleotide sequencer 110. In some implementations, only reads with certain lengths are selected.

The trace reconstruction system 102 analyzes the noisy reads 202 according to the techniques of this disclosure and generates a consensus output sequence 204. The consensus output sequence 204 represents the sequence of nucleotides in the DNA strand 200 with less error than any of the individual noisy reads 202 and ideally with no error.

A converter 206 converts the consensus output sequence 204 into binary data 208, thereby retrieving the digital information stored in the DNA storage library 106. The converter 206 may use additional error correction techniques to correct any errors that may remain in the contents output sequence 204. Thus, it is not necessary for the trace reconstruction system 102 to correct all types of errors because there are other error correction techniques that may be used to recover the binary data 208.

Although the implementation discussed herein relates to obtaining binary data 208 from reads of a synthetic DNA strand 200, the trace reconstruction system 102 operates equally well on reads of natural DNA strands. The output from the polynucleotide sequencer 110 is a plurality of noisy reads 202 for both synthetic DNA and natural DNA. Thus, the trace reconstruction system 102 may be used to remove errors from reads generated by the polynucleotide sequencer 110 in implementations that do not involve the use of synthetic DNA to store binary data 208.

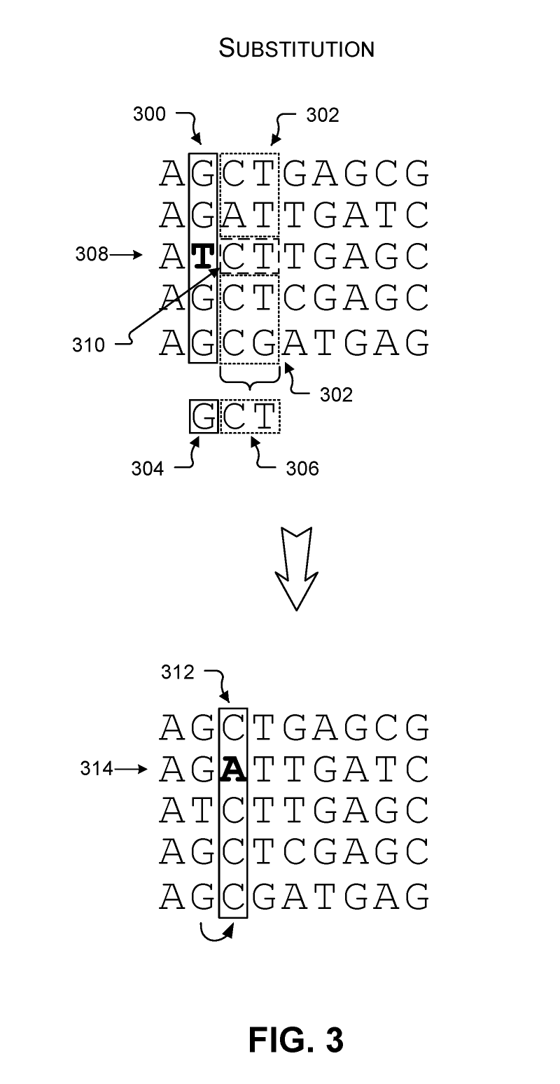

FIG. 3 shows a technique for identifying a substitution error. The reads may be aligned at a starting position or any other position. The starting position may correspond to the 5′ end of the DNA strand that generated the read. In the figures of this disclosure the 5′ end is oriented to the left. A position of comparison 300 spanning the reads is represented by the solid rectangular box. The position of comparison 300 may move along the reads from left to right as each position in the reads is analyzed in turn. Immediately following the position of comparison 300 is a look-ahead window 302 represented by two dotted rectangular boxes. The look-ahead window 302 “looks ahead” to the right, or towards the 3′ end, of the position of comparison 300. That is, if the read is represented as Yj and the position of comparison 300 is represented as p[j], then the look-ahead window 302 of length w is the substring consisting of Yⱼ[p[j]+1], . . . Yⱼ [p[j]+w]. The look-ahead window 302 may move along the reads as the position of comparison 300 moves. In this example, the length of the look-ahead window 302 is two positions, but it may be longer such as three, four, or more.

A plurality consensus base 304 is the most frequent base call at the position of comparison 300. Here, four of the five reads has G at this position and one read has T. Because G is the most numerous base call, the plurality consensus base 304 is G. In some implementations, the plurality consensus base 304 may be determined by consideration of quality information for the respective base calls at the position of comparison 300. Each base call in the position of comparison 300 may be weighted based on associate quality information. For example, if there is 80% confidence that a given base call is a G then that may count as 0.8 G towards a determination of the plurality consensus base 304 while 30% confidence that a given base call is C will count as 0.3 C towards the determination of the plurality consensus base 304. Thus, the confidence of individual base calls may be considered in identifying the plurality consensus base 304 for a given position of comparison 300. Additionally or alternatively, all base calls with quality information indicating a confidence in the base call less than a threshold level (e.g., 15%) may be omitted from the determination of the plurality consensus base 304.

A read that has a base call at the position of comparison 300 that differs from the plurality consensus base 304 is referred to as a variant read. Thus, for variant read Yₖ the base call Yₖ[p[k]] does not agree with the plurality consensus base 304. A variant read in this example is the third strand 308. Out of any grouping of reads, when analyzed at a given position of comparison 300, there may be zero, one, or more than one variant reads.

A look-ahead window consensus 306 is determined from the look-ahead window 302 in a similar manner as the plurality consensus base 304. Determination of the look-ahead window consensus 306 may also be influenced by quality information. The look-ahead window consensus 306 may be based on base calls weighted by their respective confidence levels and/or by omitting base calls with confidence levels below a threshold. The look-ahead window consensus 306 is determined by consideration of reads that are not variant reads for the position of comparison 300. Thus, the look-ahead window 302 is shown here as covering the non-variant reads but not covering the variant read 308. In this example, the most common base call in the first position of the look-ahead window 302 is C and the most common base call the second position of the look-ahead window 302 is T. Thus, the look-ahead window consensus 306 is a two-position string of the base calls: CT.

Next, the base calls in the look-ahead window of the variant read 310 (CT) are compared to the look-ahead window consensus 306 (CT). Because they match, the mismatch at the second position in the third read 308 is classified as a substitution. In mathematical notation, if Yₖ [p[k]+1], . . . Yₖ [p[k]+w] agrees with the look-ahead window consensus, then classify the mismatch in Yₖ as a substitution. The plurality consensus base 304 is used as the base call for that position in the consensus output sequence 204.

After the type of error for the variant read is classified, the position of comparison 300 is moved to continue analysis of the reads. The position of comparison 300 is moved one position to the right for each of the reads that are not variant reads. In this example, these are the first, second, fourth, and fifth reads. For, variant reads in which the error type is classified as substitution, here that is the third read 308, the position of comparison 300 is also moved one position to the right. Thus, as shown in the lower portion of FIG. 3, the position of comparison 300 is moved one position to the right for all of the reads. The analysis repeats at this new position of comparison 312 and in this iteration the second read 314 is identified as a variant read.

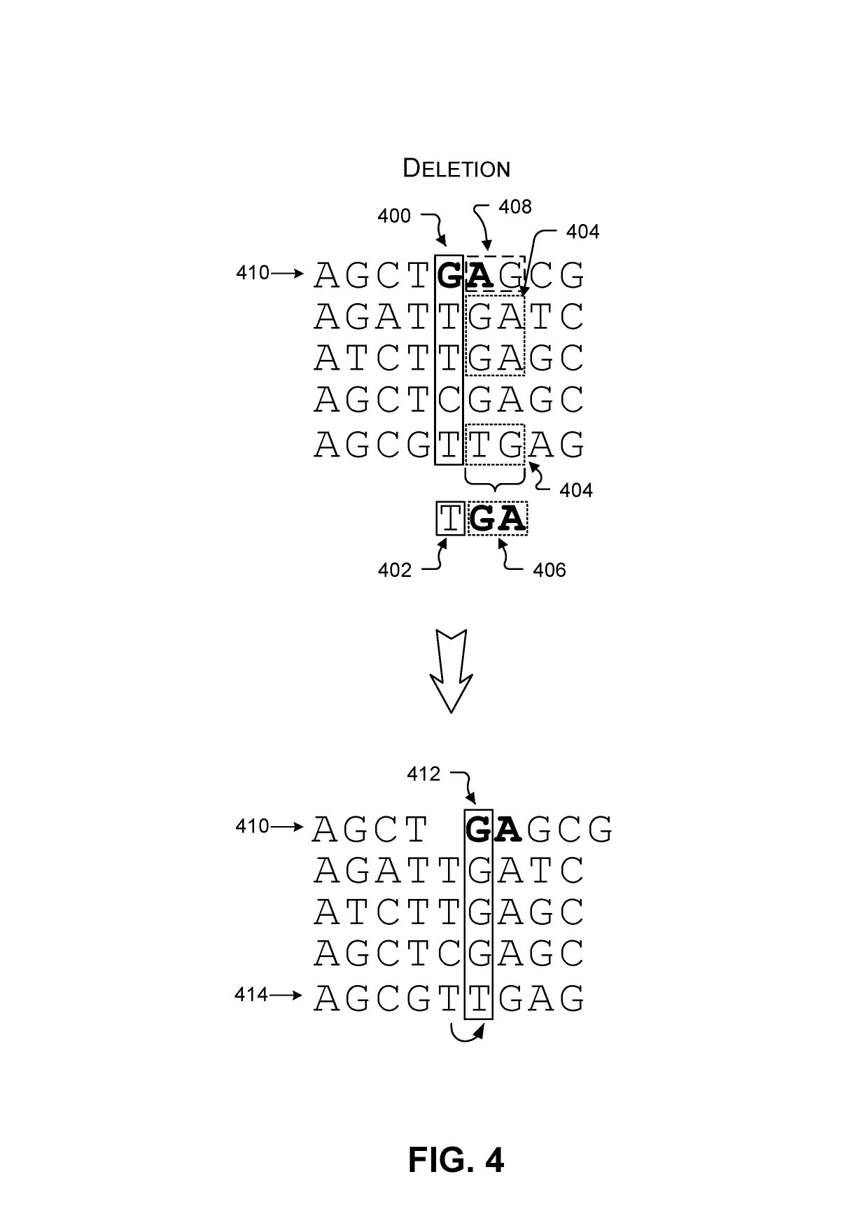

FIG. 4 shows a technique for identifying a deletion error. The position of comparison 400 is again analyzed to determine the most frequent base call at that position. In this example, three of the five strands have the base call T, one strand has the base call G, and one strand has the base call C. Thus, the most common base call is T and the plurality consensus base 402 for this position in the reads is T. The first strand 408 and the fourth strand are identified as variant reads.

Base calls in the look-ahead window 404 for the strands that are not variant reads are compared to determine a look-ahead window consensus 406. In this example, the value of the two base calls in the look-ahead window 404 for the three non-variant reads is GA, GA, and TG. The most common series of base calls is thus GA and this becomes the look-ahead window consensus 406.

The value of the base calls in the look-ahead window 408 (AG) for the first strand 410 is not the same as the look-ahead window consensus 406 (GA). The type of error responsible for the mismatch in the first strand 410 is therefore not classified as a substitution. However, the base calls in the position of comparison 400 and all but the final position of the look-ahead window 404 (GA) match the look-ahead window consensus 406 (GA). Thus, the type of error for this position of the first strand 408 is classified as a deletion. In this example, the length (w) of the look-ahead window 404 is two, so all but the final position of the look-ahead window 404 is w−1 or the first base of the look-ahead window 404. If the look-ahead window 404 has length (w) three, then the first two bases (3-1) of the look-ahead window 404 would be considered when determining if the type of error in the variant read is a deletion. In mathematical notation, if Yₖ [p[k]], . . . Yₖ [p[k]+w−1] agrees with the look-ahead window consensus, then classify the mismatch in Yₖ as a deletion.

After the type of error for the variant read is classified, the position of comparison 400 is moved one position to the right for each of the reads that are not variant reads and for each of the reads for which the error is classified as a substitution. For the first strand 410 in which there is classified as a deletion, the position of comparison 400 is not moved. It remains at the same G located in the fifth position of the first strand 408. The deletion becomes evident as shown in the lower portion of FIG. 4 after realignment of the strands following the differential movement to a new position of comparison 412 for the first strand 410 (i.e., by zero) and for the other strands (i.e., by one). This realignment due to moving to the new position of comparison 412 different amounts based on the classification of the error type keeps the strands in phase improving further analysis farther along the strands. After the new position of comparison 412 is moved (or not depending on the error type) the analysis can repeat, here identifying a mismatch in the fifth strand 414.

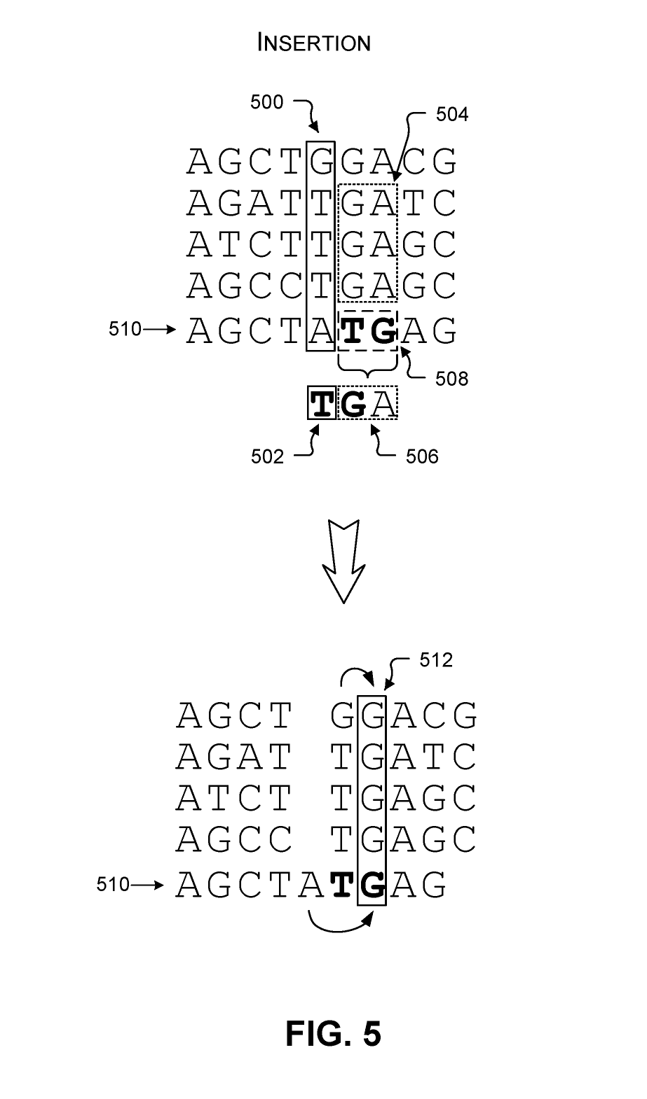

FIG. 5 shows a technique for identifying an insertion error. As discussed above, the three possible error types are substitution, deletion, and insertion. As with identification of substitution and deletion errors, identification of insertion errors begins with analyzing the base calls in a position of comparison 500 to determine a plurality consensus base 502 and analyzing base calls in a look-ahead window 504 to identify a look-ahead window consensus 506. In this example, the plurality consensus base 502 is T. The fifth read 510 is a variant read because it has an A rather than a T at the position of comparison 500. The base calls for the look-ahead window consensus 506 is GA. The base calls in the look-ahead window 508 for fifth read 510 do not match the look-ahead window consensus 506 so the error type is not classified as a substitution. The base call in the position of comparison 500 and the first base call in the look-ahead window 508 for the variant read (AT) do not match the look-ahead window consensus 506 (GA) so the error type is not classified as a deletion.

However, the base calls in the look-ahead window 508 of the fifth read 510 match the base calls of the plurality consensus base 502 and all but the final base call (i.e., w−1 positions) of the look-ahead window consensus 506 (i.e., both are TG). Thus, the error is classified as insertion of an A at the 5th position of the fifth strand 510. In mathematical notation, if Yₖ[p[k]+1] agrees with the plurality consensus base 502, and Y k[p[k]+2], . . . Yₖ[p[k]+w] agrees with the first w−1 coordinates of the look-ahead window consensus 506, then the mismatch in Yₖ is classified as an insertion. This insertion error becomes evident as shown in the lower portion of FIG. 5 after realignment of the strands following differential movement of the position of comparison 500 to a new position of comparison 512. The position of comparison 500 is advanced two positions for the read that had the insertion, here that is the fifth read 510. For the other strands, the position of comparison 500 is advanced one position to the new position of comparison 512 for reads that are not variant reads, one position for reads that have substitutions, and zero positions for reads that have deletion errors.

The examples shown in FIGS. 3-5 illustrate analysis of only one type of error each. However, the techniques of this disclosure are equally applicable to groups of reads that have multiple errors in one position of comparison. There may also be multiple error types across a single position of comparison, for example, out of a total of 20 reads (m=20) three reads could have substitutions, one read could have a deletion, and one read could have an insertion.

There may also be situations in which it is not possible to identify the type of error. A read may have a base call in the position of comparison that does not match the plurality consensus base call, thus it is a variant read, but the base calls in the position of comparison and the look-ahead window may not exhibit the relationships classified as substitution, deletion, or insertion. This is an identified error that cannot be classified according to the techniques described above. Additionally, there may be a relationship between the base calls in the position of comparison and in the look-ahead window that are indicative of two different types of errors. This is an identified error which can be classified as one of two error types but the techniques described above cannot confidently resolve the error to a single type.

One way of handling reads that have ambiguous errors is to discard the read from further processing. Thus, if a read has an error and it cannot be resolved to a single error type, that read is omitted from further analysis. Another way of handling ambiguous errors is to use a bias or tiebreaker in order to force a classification. The bias may be based on an error profile of the polynucleotide sequencer used to generate the reads. For example, if the polynucleotide sequencer is known to generate substitution errors much more frequently than either deletion or insertion errors, all ambiguous errors could be classified as substitutions. If an error can be identified as one of two possible error types, the relative frequency of those error types for the polynucleotide sequencer technology may be used to choose between them. For example, if an error has been identified as either a deletion or insertion (but not a substitution) and the polynucleotide sequencer makes 80% substitution errors, 15% deletion errors, and 5% insertion errors, that error may be classified as a deletion error because deletion errors are more likely than insertion errors in this example.

Additionally or alternatively, the quality information of individual base calls may be used to classify ambiguous errors. In one implementation, when an error is unable to be resolved to a single error type, all base calls in the position of comparison and the look-ahead window with quality information indicating a base call confidence of less than a threshold level may be omitted from the determination of the plurality consensus base and the look-ahead window consensus. Thus, the consensus base calls for the relevant positions are determined on the most reliable base calls from the multiple reads. Ignoring the low-confidence base calls may lead to the techniques described above being able to resolve the error to a single error type.

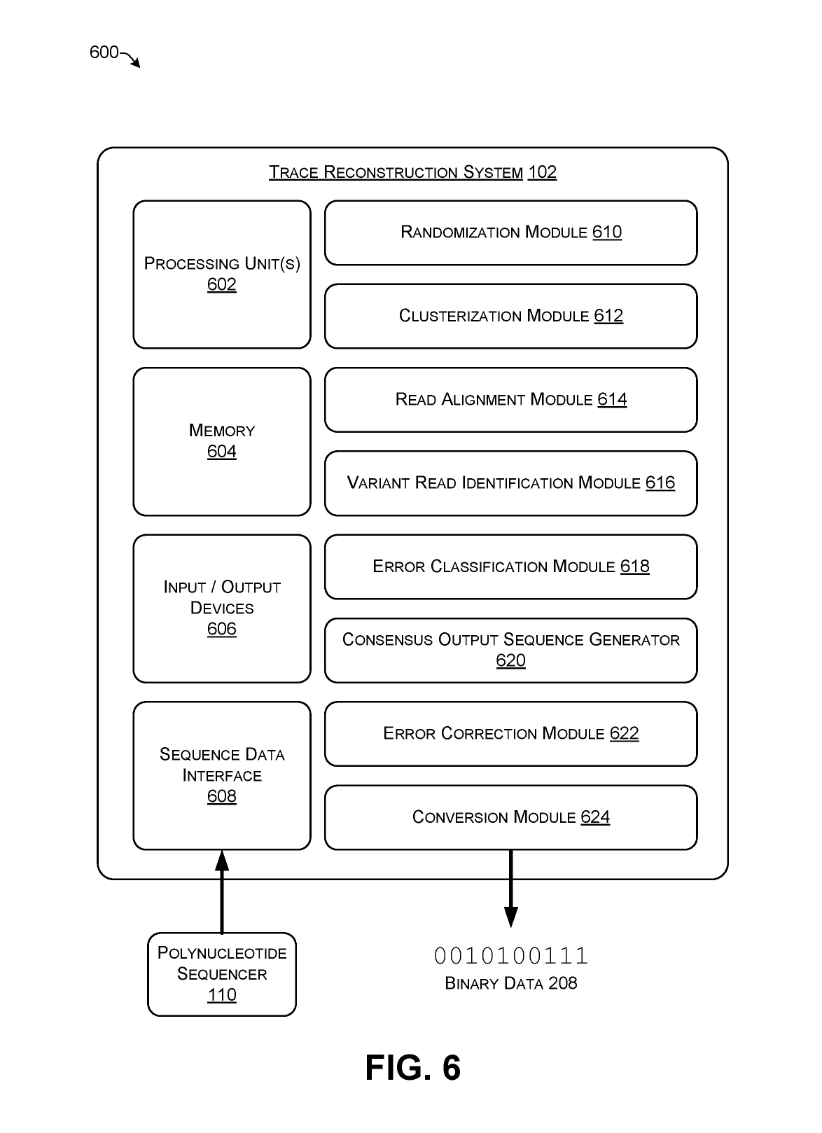

FIG. 6 shows an illustrative block diagram 600 of the trace reconstruction system 102 shown in FIG. 1. Recall that the trace reconstruction system 102 may be implemented in whole or in part in any of the computing device 112, the polynucleotide sequencer 110, and the servers 114. Thus, the trace reconstruction system 102 may be implemented in a system that contains one or more processing unit(s) 602 and memory 604, both of which may be distributed across one or more physical or logical locations. The processing unit(s) 602 may include any combination of central processing units (CPUs), graphical processing units (GPUs), single core processors, multi-core processors, application-specific integrated circuits (ASICs), programmable circuits such as Field Programmable Gate Arrays (FPGA), and the like. One or more of the processing unit(s) 602 may be implemented in software and/or firmware in addition to hardware implementations. Software or firmware implementations of the processing unit(s) 602 may include computer- or machine-executable instructions written in any suitable programming language to perform the various functions described. Software implementations of the processing unit(s) 202 may be stored in whole or part in the memory 604.

Alternatively or additionally, the functionality of the trace reconstruction system 102 can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Implementation as hardware logic components may be particularly suited for portions of the trace reconstruction system 102 that are included as onboard portions of the polynucleotide sequencer 110.

The trace reconstruction system 102 may include one or more input/output devices 606 such as a keyboard, a pointing device, a touchscreen, a microphone, a camera, a display, a speaker, a printer, and the like.

Memory 604 of the trace reconstruction system 102 may include removable storage, non-removable storage, local storage, and/or remote storage to provide storage of computer-readable instructions, data structures, program modules, and other data. The memory 604 may be implemented as computer-readable media. Computer-readable media includes at least two types of media: computer-readable storage media and communications media. Computer-readable storage media includes volatile and non-volatile, removable and non-removable media implemented in any method or technology for storage of information such as computer-readable instructions, data structures, program modules, or other data. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communications media may embody computer-readable instructions, data structures, program modules, or other data in a modulated data signal, such as a carrier wave, or other transmission mechanism. As defined herein, computer-readable storage media and communications media are mutually exclusive.

The trace reconstruction system 102 may be connected to one or more polynucleotide sequencers 110 through a direct connection and/or a network connection by a sequence data interface 608. The direct connection may be implemented as a wired connection, a wireless connection, or both. The network connection may travel across the network 116. The sequence data interface 608 receives one or more reads from the polynucleotide sequencer 110.

The trace reconstruction system 102 includes multiple modules that may be implemented as instructions stored in the memory 604 for execution by processing unit(s) 602 and/or implemented, in whole or in part, by one or more hardware logic components or firmware.

A randomization module 610 randomizes input digital data before encoding it in DNA with oligonucleotide synthesizer 104. The randomization module 610 may create a random, more accurately pseudo-random, string from the input digital data by taking the exclusive-or (XOR) of the input string and a random string. The random string may be generated using a seeded pseudo-random generator based on a function and a seed. Such randomization of the input digital data increases randomness in synthetic DNA strands 200 which results in the noisy reads 202 coming from a polynucleotide sequencer 110 themselves having pseudo-random sequence of A, G, C, and T. The randomness facilitates decoding (i.e., clustering and trace reconstruction).

A clusterization module 612 clusters a subset of the plurality of reads based on a likelihood of the subset of the plurality of reads being derived from a same DNA strand. Data received of the sequence data interface 608 from a polynucleotide sequencer 110 may contain a set of reads generated from multiple DNA strands. Although there may be errors in many of the reads, the reads from a same DNA strand are generally more similar to each other than they are to reads from a different DNA strand. Further analysis would be hampered if the set of reads to be analyzed includes reads of different DNA strands. Thus, clustering may be performed in order to limit the data for further analysis to a subset of the reads that are believed to represent the same DNA strand. A poorly formed cluster may be “poorly” formed due to over or under inclusion. An overly inclusive, poorly formed cluster is one that groups reads of more than one strand in a single cluster. An under inclusive, poorly formed cluster in of multiple clusters that should be grouped into a single large cluster but instead are divided into multiple smaller clusters. The clusterization module 612 can use any suitable clustering technique such as connectivity-based clustering (e.g., hierarchical clustering), centroid-based clustering (e.g., k-means clustering), distribution-based clustering (e.g., Gaussian mixture models), density-based clustering (e.g., density-based spatial clustering of applications with noise (DBSCAN)), etc. The trace reconstruction system 102 may analyze one or more, including all, of the clusters derived from the data output by the polynucleotide sequencer 110.

A read alignment module 614 aligns the plurality of reads at a position of comparison spanning the plurality of reads. Initially, the left ends of the reads (corresponding to the 5′ ends of the DNA strands) may be aligned. This first position in the reads may be used as the initial position of comparison. As analysis proceeds, the read alignment module 614 moves the position of comparison along each read a number of positions based on identified error types.

The read alignment module 614 advances the position of comparison by one position for reads that have the plurality consensus base call at the position of comparison, by one position for a variant read if the error type is classified as substitution, by zero positions for a variant read if the error type is classified as deletion, or by two positions for a variant read if the error type is classified as insertion.

The read alignment module 614 may also generate a “reverse” alignment that begins with the reads aligned at the right end (corresponding to the 3′ ends of the DNA strands). Analysis then proceeds in an identical manner except that movement to the “right” becomes movement to the left. The consensus output sequence 204 is potentially different for the same set of reads when analyzed from left to right as compared to right to left.

Generally, the accuracy of a consensus output sequence 204 is more accurate towards the beginning of the reads. Without being bound by theory, it is possible that any errors may accumulate and cause further errors in analysis of subsequent positions along the reads. For example, if a deletion error is incorrectly identified as a substitution error, the remaining base calls in that read may be out of phase and negatively impact the accuracy of subsequent error identification. One way of minimizing this effect is to use the first half of the “forward” analysis and the first half of the “reverse” analysis. Say, for example that the length of the reads to be analyzed is 100 positions. A left-to-right analysis may be performed that provides a consensus output sequence 204 for the first 50 positions. A right-to-left analysis may be performed that provides a consensus output sequence 204 for the last 50 positions. Both analyses may be performed in parallel. The resulting consensus output sequence 204 is a combination of the 50 base pairs identified by the left-to-right analysis and the 50 base pairs identified by the right-to-left analysis. This is referred to as a combined consensus output sequence.

A variant read identification module 616 determines a plurality consensus base call at the position of comparison and labels a read that has a different base call at the position of comparison as a variant read. In some implementations, the variant read identification module 616 may use an error profile associated with the polynucleotide sequencer 110 as discussed above to determine the plurality consensus base call. The variant read identification module 616 may flag or otherwise identify every read that is a variant read for a given position of comparison. This flag will then identify that read as one that should be identified for determination of an error type. With each movement of the position of comparison, the identity of which reads are variant reads and which are not variant reads changes.

An error classification module 618 classifies an error type for variant reads as substitution, deletion, or insertion. If an error cannot be uniquely classified, the error classification module 618 may indicate that the type of error is indeterminate or that the error type is limited to one of two possibilities. Classification of an error by the error classification module 618 may be based at least in part on comparison of a consensus string of base calls in a look-ahead window of a subset of the plurality of reads having the plurality consensus base call at the position of comparison (i.e., the non-variant reads) and base calls in the variant read. Variant reads other than the one being analyzed at a given iteration are not used when determining an error type.

As described above in FIG. 3, the error type is classified as a substitution upon the consensus string of base calls in the look-ahead window matching a string of base calls in the variant read following the position of comparison. As described above in FIG. 4, the error type is classified as a deletion upon the look-ahead window consensus matching the base call at the position of comparison in the variant read and one or more following positions.

As described above in FIG. 5, the error type there is classified as an insertion. It is classified as an insertion because (1) a base call in the variant read following the position of comparison (i.e., the first base call in the look-ahead window for the variant read) matches the plurality consensus base call and (2) the consensus string of base calls in the look-ahead window matching a string of base calls in the variant read equal in length to the look-ahead window and starting two positions following the position of comparison.

A consensus output sequence generator 620 determines a consensus output sequence 204 based at least in part on the plurality consensus bases and the error types identified along the reads. Each position in the consensus output sequence 204 is the plurality consensus base at that position in view of the adjusted alignment of the reads due to error type classification. An error profile of the polynucleotide sequencer 110 and/or quality information of the individual base calls may also be used to determine the consensus output sequence 204 through influencing the identification of plurality consensus bases and error types.

An error correction module 622 may apply additional error correction techniques to decode the consensus output sequence 204. In some implementations, the error correction module 622 uses a non-binary error-correcting code to decode the consensus output sequence 204 based in part on redundant data that is encoded into the strands. One example of this type of error correction is Reed-Solomon error correction. In an example implementation, a Reed-Solomon outer code may be added to the starting binary data and ultimately distributed across approximately many strands of DNA (e.g., 10,000-100,000 strands) when stored. It is possible that the Reed-Solomon error correction may fail to decode the consensus output sequence 204 if there are more than a threshold number of errors. If this occurs, trace reconstruction may be repeated with a change in one of the parameters. Changing a parameter may result in a different consensus output sequence 204 that the Reed-Solomon error correction is able to decode. The length of the look-ahead window (w) is one parameter that could be changed. A look-ahead window of length three could be used instead of a look-ahead window of length two (or vice versa). Cut off thresholds for discarding whole reads, accepting a base call based on quality information, and biasing an error type classification for ambiguous errors could all be varied by making them more lenient or more strict. After changing one or more parameters, it can be determined if the consensus output sequence 204 is different from the previous consensus output sequence 204, and if it is, Reed-Solomon error correction may be applied to the new consensus output sequence 204 to see if it is able to decode the sequence.

A conversion module 624 converts the consensus output sequence into binary data 208 representing at least a portion of a digital file. The conversion from a series of base calls to a string of binary data 208 is performed by reversing the operations that were originally used to encode the binary data 208 as a series of base calls. These operations will be known to the entity that operates the DNA storage library 106. In some implementations, the converter 206 introduced in FIG. 2 may include the same functionalities as the conversion module 624 as well as possibly the error correction module 622. The binary data 208 may be used in the same manner as any other type of binary data. If the various error correction techniques are sufficient, the binary data 208 will represent a perfect reproduction of the original binary data.

### Illustrative Processes

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process, or an alternate process. Moreover, it is also possible that one or more of the provided operations is modified or omitted.

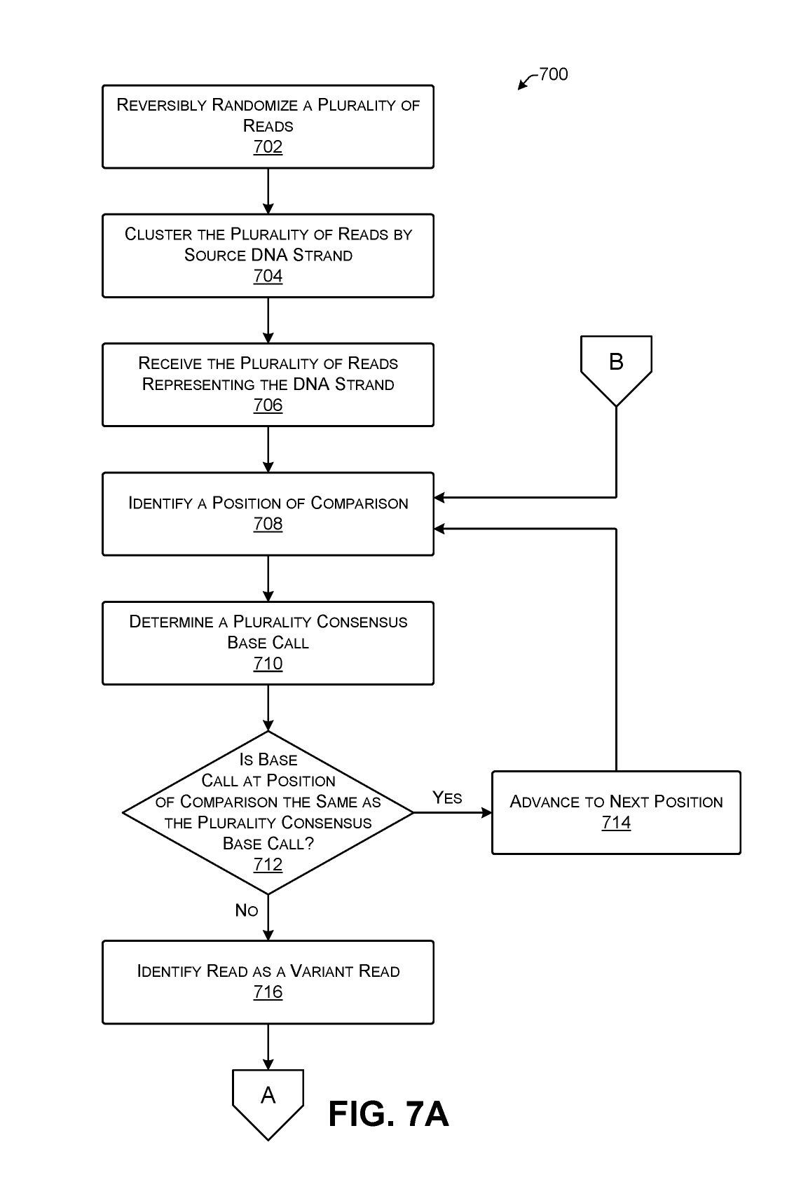

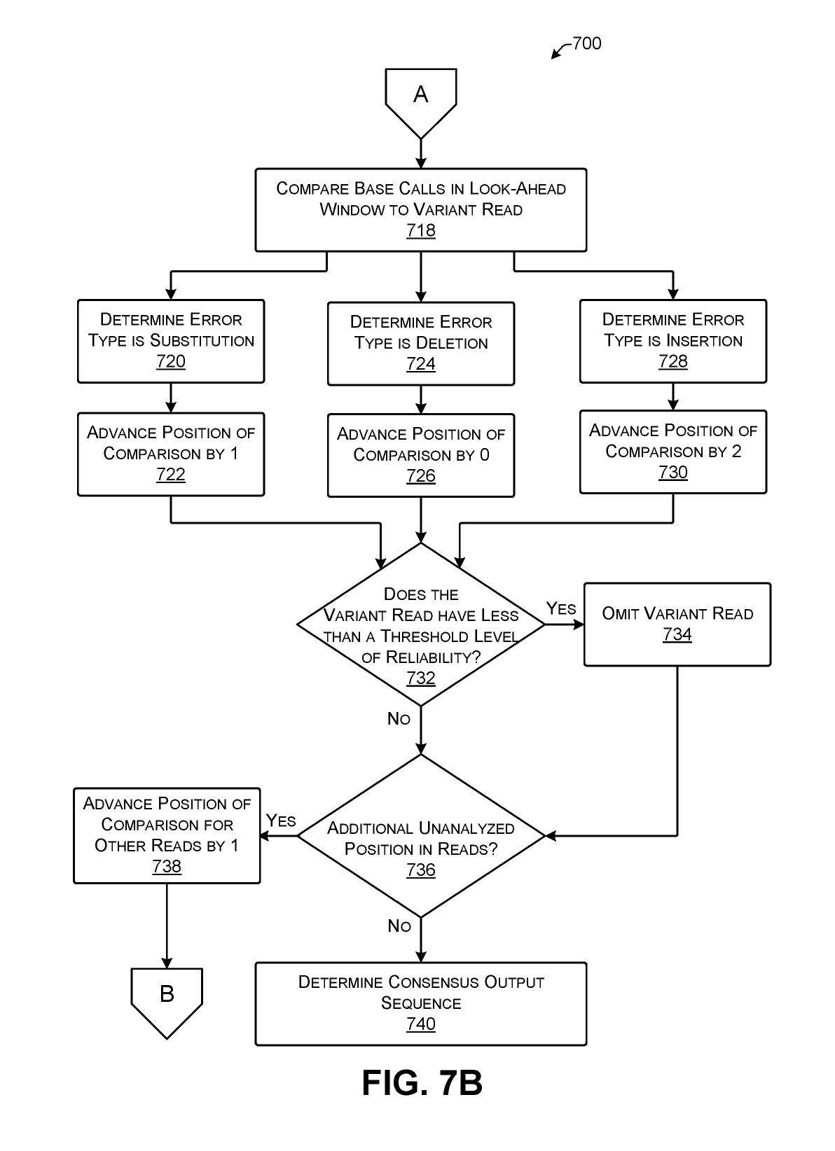

FIGS. 7A and 7B show process 700 for correcting errors in sequence data generated by a polynucleotide sequencer. The process 700 may be implemented by the trace reconstruction system 102 shown in FIGS. 1, 2, and 6.

At 702, binary data to be encoded as one or more DNA strands is inversely randomized. Although this randomization occurs for creation of DNA strands 210, randomization is present in all reads. The plurality of reads may be received via the sequence data interface 608 shown in FIG. 6. The reads may be randomized by the randomization module 610 shown in FIG. 6.

At 704, the sequence data generated by the polynucleotide sequencer are clustered using a clustering technique. Any suitable clustering technique may be used and one of ordinary skill in the art will be able to identify a suitable clustering technique. Clustering creates groups of reads derived from the same source DNA strand. Clustering may be performed by the clusterization module 612 shown in FIG. 6. In some implementations, performing the clustering on randomized data improves the ability of the clustering technique to separate accurately the plurality of reads into distinct groups. A poorly formed cluster is one that contains reads derived from different DNA strands. Techniques such as discarding reads that deviate more than a threshold amount from a consensus sequence may prevent poorly formed clusters from impacting the final consensus output sequence.

At 706, a plurality of reads classified as representing a DNA strand are received for further analysis. The reads may be classified as representing the same DNA strand based on clustering performed at 704. The plurality of reads may also be classified as representing the same DNA strand due to use of a sequencing technique in which the input for the polynucleotide sequencer is only a single DNA strand (or essentially identical copies thereof produced by PCR). In some implementations, the plurality of reads may be received via the sequence data interface 608 shown in FIG. 6. In other implementations, the plurality of reads may be received following clustering performed by the clusterization module 612.

At 708, a position of comparison spanning the plurality of reads is identified. The position of comparison may be similar to the position of comparison 300 shown in FIG. 3, the position of comparison 400 shown in FIG. 4, or the position of comparison 500 shown in FIG. 5. In an implementation, the position of comparison may be identified by the read alignment module 614 shown in FIG. 6.

At 710, a plurality consensus base call at the position of comparison is determined by identifying the most common base call at that position. As described above, the most common base call may be identified in part by consideration of quality information for the base calls present at the position of comparison. In an implementation, the plurality consensus base call may be determined by the variant read identification module 616 shown in FIG. 6.

At 712, it is determined if the base call at the position of comparison is the same as the plurality consensus base call. If it is the same, then the read being analyzed has the expected base call at this position, is not a variant read, and process 700 follows “yes” path to 714.

At 714, process 700 advances to the next position along the read. If, however, the base call at the position of comparison does not match the plurality consensus base call, process 700 follows “no” path from 712 to 716.

At 716, a read from the plurality of reads that has a base call in the position of comparison that differs from the plurality consensus base call is identified as a variant read. In an implementation, this identification may be performed by the variant read identification module 616 shown in FIG. 6.

Moving to FIG. 7B, at 718, a consensus string of base calls in a look-ahead window adjacent to the position of comparison is compared to base calls in the variant read. The consensus string of base calls in the look-ahead window may be limited to the base calls from the subset of reads that has the plurality consensus base call at the position of comparison. For example, in a set of 10 or 20 reads more than one may be variant reads due to the base call at the position of comparison not matching the plurality consensus base call. When a comparison is made for one of the variant reads the base calls in the look-ahead window of the other variant reads are not considered. This is because the other variant reads may have deletion or insertion errors that would cause the base calls in the look-ahead window to be out of phase and possibly incorrect. A type of error can be determined for the variant read based at least in part on this comparison. In an implementation, this comparison may be performed by the error classification module 618 shown in FIG. 6. In one implementation, a length of the look-ahead window may be two positions. In one implementation, a length of the look-ahead window may be three positions. In one implementation, a length of the look-ahead window may be four positions.

At 720, the error type for the variant read is determined to be a substitution based on the consensus string of base calls in the look-ahead window being the same as the string of base calls in a look-ahead window following the position of comparison for the variant read. Thus, the look-ahead window of the variant read matches the look-ahead window of the non-variant reads. This relationship is shown, for example, in FIG. 3.

At 722, the position of comparison for the variant read is advanced one position.

At 724, the error type for the variant read is determined to be a deletion based on the consensus string of base calls in the look-ahead window being the same as a string of base calls in the variant read including the base call in the position of comparison and adjacent base calls. The length of this string of base calls in the variant read is equal in length to the length of the look-ahead window. Thus, for example, if the length of the look-ahead window is three positions, the string of base calls in the variant read includes the base call in the position of comparison and the next two base calls. This relationship is shown, for example, in FIG. 4.

At 726, the position of comparison for the variant read is advanced zero positions. Because there is a deletion, not advancing the position of comparison for the variant read re-aligns the strands so that the strands will be in phase for subsequent analysis.

At 728, the error type for the variant read is determined to be an insertion based on base calls matching two specific ways. First, a base call in the variant read following the position of comparison is the same as the plurality consensus base call and, second, the consensus string of base calls in the look-ahead window is the same as a string of base calls in the variant read sequence. The string of base calls in the variant read sequence is equal in length to the look-ahead window and a starting position for this string of base calls is two positions after the position of comparison. This relationship is shown, for example, in FIG. 5.

At 730, the position of comparison for the variant read is advanced by two positions. The position of comparison is advanced one position to account for the insertion and advanced a second position because the position of comparison is advanced one position for all of the non-variant strands. This maintains alignment between the strands for subsequent analysis.

In each of 720, 724, and 728, the error type for the variant read at the position of interest may be determined based at least in part on an error profile associated with the polynucleotide sequencer. Consideration of the error profile of the polynucleotide sequencer may change either or both of the determination of the plurality consensus base call and the consensus string of base calls in the look-ahead window. In an implementation, consideration of the error profile may be performed by the consensus output sequence generator 620.

At 732, it is determined if the variant read has less than a threshold level of reliability. The threshold level may be a number of errors in the variant read; a number of errors in the variant that cannot be uniquely classified; a minimum, median, or mode of the confidence levels for base calls in the variant read; or other factor(s). The threshold number may be a number of positions ranging from one to the total number of positions in the variant read. The threshold number may also be a percentage ranging from 1% to 100%. If the variant read has less than the threshold level of reliability, process 700 proceeds along the “yes” path to 734.

At 734, the variant read is omitted and a single consensus output sequence from the plurality of reads is determined without using the variant read. Following omission of the variant read, process 700 proceeds to 736. Alternatively, if the variant read does not have less than the threshold level of reliability (i.e., it is considered reliable) the variant read is used for further analysis and process 700 proceeds along the “no” path to 736.

At 736, it is determined if there are additional unanalyzed positions in the reads. Thus, it is determined if the “end” of the reads has been reached and a plurality consensus base call has been identified for the positions of the reads. If analysis has not yet reached the end, then process 700 proceeds along the “yes” path to 738.

At 738, the position of the subset of the plurality of reads having the plurality consensus base call at the position of comparison (i.e., the non-variant reads) is advanced by one. The new position of comparison for the variant read is advanced by an amount based on the identified error type at 722, 726, or 730. The new position of comparison may be similar to new positions of comparison 310, 410, and 510 shown in FIGS. 3-5. Process 700 then returns to 708 and analysis continues.

At 736, if there are no unanalyzed positions in the reads, then process 700 proceeds along the “no” path to 740.

At 740, a single consensus output sequence is determined based in part on the plurality consensus base call and the error type. The single consensus output sequence may be determined by the consensus output sequence generator 622 shown in FIG. 6.

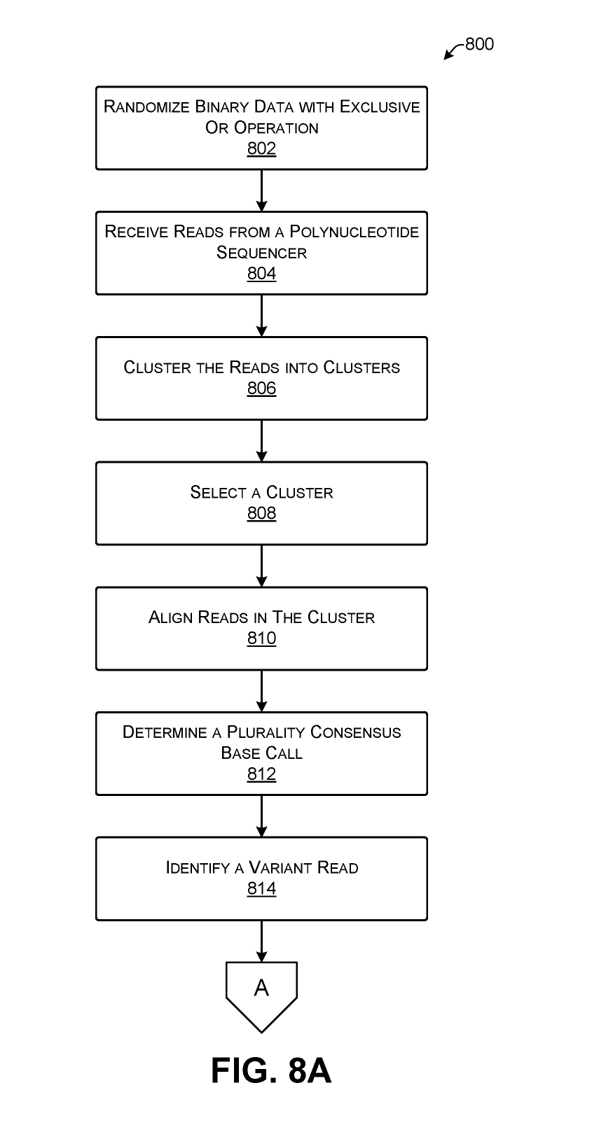

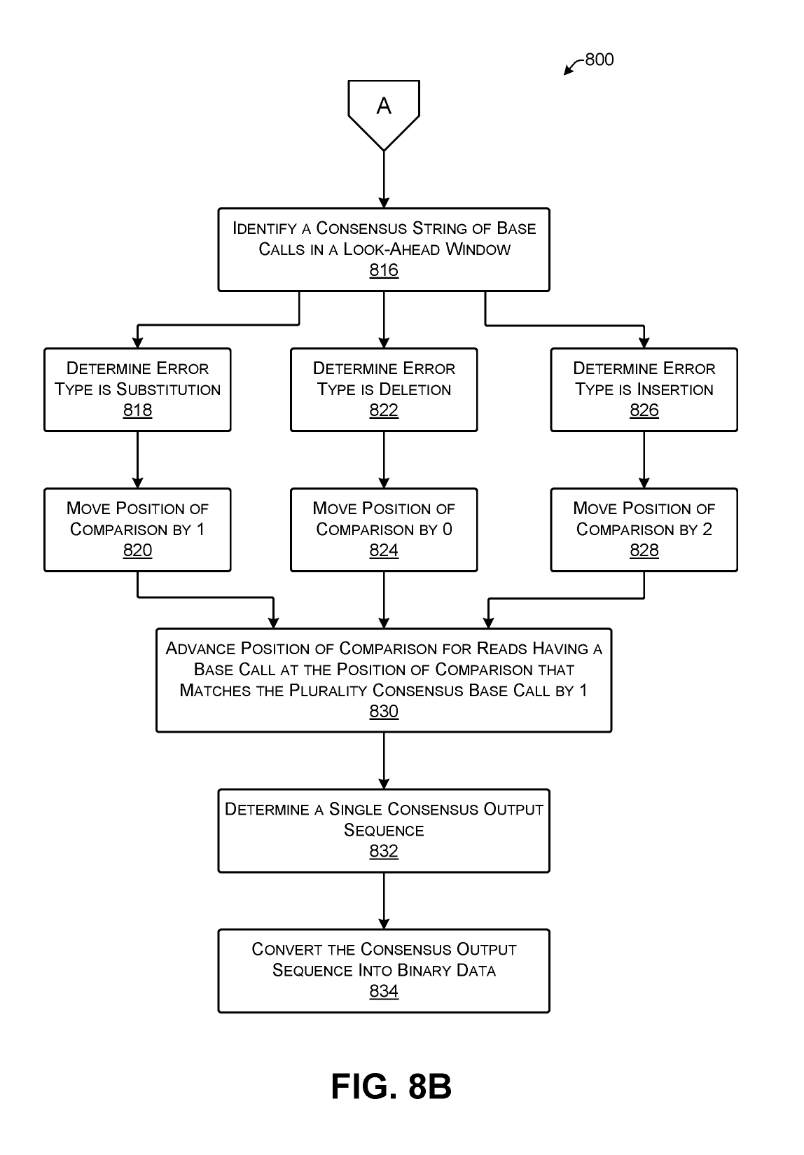

FIGS. 8A and 8B show process 800 for recovering binary data encoded in a synthetic DNA strand. The process 800 may be implemented by the trace reconstruction system 102 shown in FIGS. 1, 2, and 6.

At 802, binary data to be encoded as DNA is reversibly randomized by taking the exclusive or (XOR) of the binary data and a random sequence generated by a seed and a function. This operation affects the DNA strands that, when read, produce reads that also have characteristics of being randomized. In an implementation, the randomization may be performed by the randomization module 610 shown in FIG. 6

At 804, a plurality of reads are received from a polynucleotide sequencer. In an implementation, the plurality of reads may be received by the sequence data interface 608 shown in FIG. 6.

At 806, the plurality of reads is clustered into a plurality of clusters by sequence similarity. Similar sequences are likely to have originated from sequencing of the same DNA strand (the sequences are not identical due to errors introduced by the polynucleotide sequencer). Thus, one cluster should represent all the reads that came from the same DNA strand. Recall that the polynucleotide sequencer may sequence multiple different DNA strands simultaneously so the raw output of sequence data from the polynucleotide sequencer could include reads that correspond to the multiple different DNA strands. In an implementation, clustering may be performed by the clusterization module 612 shown in FIG. 6.

At 808, a cluster is selected from the plurality of clusters. The cluster contains a clustered set of reads. If the clustering was accurate, all the reads in the clustered set of reads come from sequencing of the same DNA strand. At this point, prior to additional analysis, the cluster is identified only by its characteristic of having reads that cluster together. So in some implementations, each cluster is analyzed in turn and the order of selecting individual clusters may be arbitrary. Multiple ones of the clusters may also be analyzed in parallel. In an implementation, selection of a cluster may be performed by the clusterization module 612 shown in FIG. 6. Analysis may continue until trace reconstruction is performed on all clusters from the plurality of clusters.

At 810, the clustered set of reads are aligned at a position of comparison spanning the clustered set of reads. In an implementation, the position of comparison may be the first position shared across the clustered set of reads. Thus, this original alignment may define a first position of comparison. The first position may be the left-most position (corresponding to the 5′ end) or alternatively the right-most position (corresponding to the 3′ end). In an implementation, alignment may be performed by the read alignment module 614 shown in FIG. 6.

At 812, a plurality consensus base call at the first position of comparison is determined. The plurality consensus base call is based at least in part on a most common base call across the clustered set of reads. The plurality consensus base call may be based in further part on an error profile associated with the polynucleotide sequencer. That is to say, base calls may be weighted based on the associated error profile (e.g., more certain base calls count for more and less certain base calls have less influence on determination of the plurality consensus base call).

At 814, a variant read from the clustered set of reads is identified. The variant read has a base call at the position of comparison that is different from the plurality consensus base call. In an implementation, the variant read may be identified by the variant read identification module 616 shown in FIG. 6.

Moving now to FIG. 8B, at 816, a consensus string of base calls in a look-ahead window is identified. The consensus string is based on base calls for a subset of the clustered set of reads having the plurality consensus base call at the position of comparison (i.e., not variant reads). The look-ahead window is adjacent to the position of comparison. In some implementations, the look-ahead window may be two or three positions long.

At 818, it is determined that an error type for the variant read at the position of comparison is a substitution based at least in part on base calls in a look-ahead window of the variant read matching the consensus string of base calls. An example of this relationship is shown in FIG. 3. In an implementation, the error type may be determined by the error classification module 618.

At 820, the position of comparison for the variant strand is moved ahead by one position.

At 822, it is determined that an error type for the variant read at the position of comparison is a deletion based at least in part on a series of base calls in the variant read including the base call at the position of comparison and one or more base calls following the position of comparison matching the consensus string of base calls. An example of this relationship is shown in FIG. 4. In an implementation, the error type may be determined by the error classification module 618.

At 824, the position of comparison for the variant strand is moved ahead by zero positions.

At 826, it is determined that an error type for the variant read at the position of comparison is an insertion. An insertion error is identified based at least in part on a base call in the variant read following the position of comparison matching the plurality consensus base call and a series of base calls in the variant read starting two positions following the position of comparison matching the consensus string of base calls. An example of this relationship is shown in FIG. 5. In an implementation, the error type may be determined by the error classification module 618.

At 828, the position of comparison for the variant strand is moved ahead by two positions.

At 830, the position of comparison for reads in the subset of the clustered set of reads (i.e., the non-variant reads) is advanced ahead one position.

At 832, a single consensus output sequence is determined from the clustered set of reads. In an implementation, the single consensus output sequence generated by the consensus output sequence generator 620 shown in FIG. 6.

At 834, the single consensus output sequence in converted into binary data. This may be the final manipulation of the information derived from the DNA strand before it is again used as a digital computer file. In an implementation, the change from sequence data to binary data may be performed by the conversion module 624 shown in FIG. 6.

### Examples

To demonstrate the feasibility recovering accurately the entire sequence of a DNA strand from noisy reads produced by a polynucleotide sequencer, tests were run using the trace reconstruction system described herein. In silica datasets used an initial DNA sequence of 100 base pairs (n=100) and randomly introduced different amounts of error ranging from no error to error in 15% of all positions in the synthetic sequencing results. Thus, for the synthetic population of reads generated from the original “DNA strand” a given 100 position read would have, on average, between 0 and 15 positions that are inaccurate. In one dataset, the errors were equally divided between the three error types. For example, if the percent of total errors was 9%, then there was a 3% chance each of substitution, deletion, and insertion errors. In another dataset, the errors were biased toward substitutions: 80% substitutions, 10% deletions, and 10% insertions. This ratio of error types is similar to the actual error type distribution of current sequencing-by-synthesis technology. Thus, for this dataset assuming a 10% total error rate, there is an 8% substitution error rate, a 1% deletion error rate, and a 1% insertion error rate.

The data in the in silica datasets is randomized to mimic the effects of randomizing (by XOR with a random sequence or other technique) the original binary data as discussed above. The results discussed below are generated from combined reads that combine a forward (left to right) read of the first 50 positions with a backwards (right to left) read of the final 50 positions. Using combined reads rather than one-way reads (e.g. just from left to right or just from right to left) produces results that are more accurate.

For all of the tests described below, the number of noisy reads used to reconstruct the original “DNA strand” was 10 (m=10). Increasing the number of reads (e.g., m=20) provided more accurate results at a linear increase in computational time. One advantage of the trace reconstruction system is that the computation time scales linearly (rather than exponentially) with the length of the sequence (n) and the number of reads (m) analyzed.

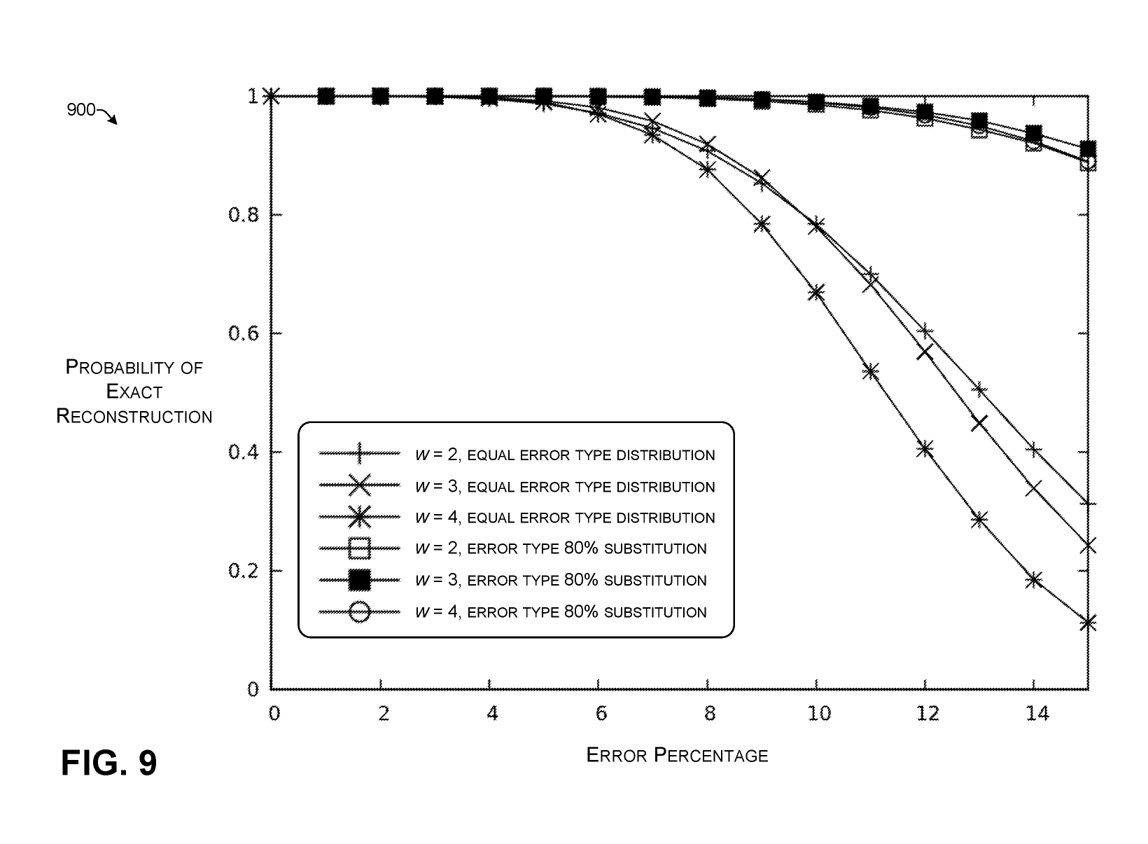

FIG. 9 shows a plot 900 illustrating how a change in error percentage affects the probability of exact reconstruction. The error percentage ranges from 0 to 15%. The probability of exactly reconstructing the original DNA strand ranges from 0 to 1. The length of the look-ahead window (w) was varied from 2 to 4 for both the dataset in which the error types are equally distributed and the dataset in which the errors are biased to substitution.

When there are no errors in the noisy reads the trace reconstruction system is always able to reconstruct the original sequence. All reads are accurate reproductions of the DNA strand. The probability of reconstruction remains at or close to 1 up through a 4% error rate. This is higher than the 2% error rate typical of current sequencing-by-synthesis technology indicating that the trace reconstruction system will yield accurate reconstructions when used with current sequencing technology. Differences emerge as the error percentage increases.

The distribution of error types has a marked effect on the accuracy of the trace reconstruction system. The test in which 80% of the errors are substitutions have a probability of exact reconstruction close to 1 for higher error percentages than the datasets in which the errors types are equally distributed. This suggests that deletion or insertion errors that can change the alignment of the reads have a greater effect on accuracy than do substitution errors. However, as mentioned above, the distribution of error types in results from sequencing-by-synthesis are close to the 80/10/10 split, so for current sequencing technology, the trace reconstruction system can achieve close to 100% exact reconstruction for error percentages as high as 10%.

The other difference apparent by these tests is the effect of the look-ahead window (w) size. A length of four provides the least favorable results. Without wishing to be bound by theory, this may be due to the longer window including more incorrect base calls from further along the reads. A window length of three is best for an error distribution that is 80% substitutions and for equally distributed error types up to a total error percentage of around 10%. At higher error percentages, a look-ahead window length of two provides better results. Without wishing to be bound by theory, the longer window length of three may suffer from including more inaccurate base calls when deletion and insertion errors (which can shift the strands out of phase) affect more than about 6% of the positions.

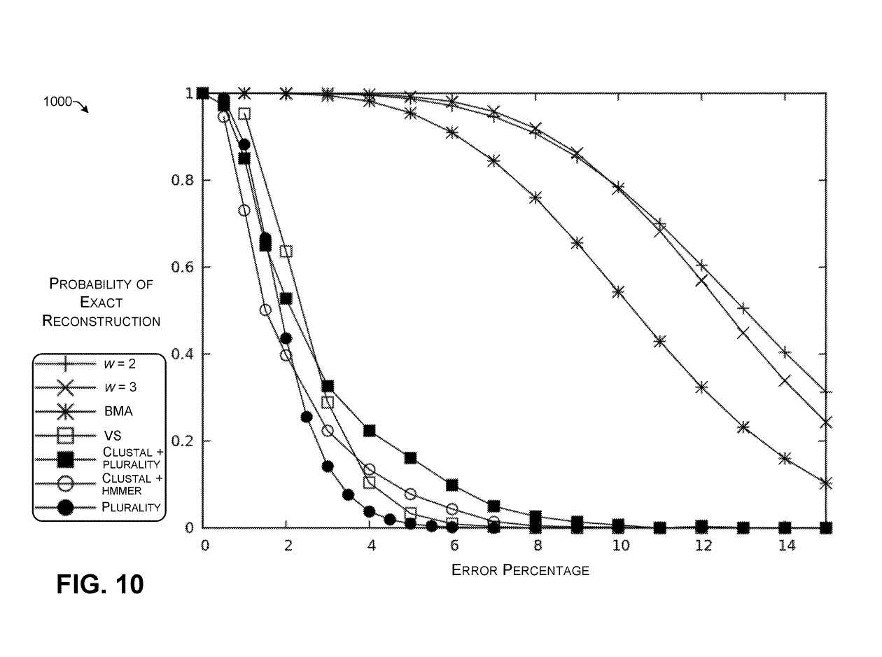

FIG. 10 shows a plot 1000 comparing results of the trace reconstruction system with alternative techniques. In these tests, the error types were equally distributed between substitution, deletion, and insertion. Thus, the lines for w=2 and w=3 show the same data as the lines from FIG. 9 for w=2, equal error type distribution and w=3, equal error type distribution. The trace reconstruction system provides higher probabilities of exact reconstruction than any of the alternate techniques.

The closest is shown by the line labeled BMA. Once the total error percentage reaches 5% BMA yields worse results than the trace reconstruction system. BMA or Bitwise Majority Alignment is described in Tugkan Batu, Sampath Kalman, Sanjeev Khanna, and Andrew McGregor. Reconstructing strings from random traces. In Proceedings of the Fifteenth Annual ACM-SIAM Symposium on Discrete Algorithms (SODA), pages 910-918. Society for Industrial and Applied Mathematics, 2004. However, BMA is designed to address only deletion errors, and thus, does poorly when the number of substitution and/or insertion errors increase.

One of the techniques with the lowest probabilities of exact reconstruction is identified as “Plurality.” This technique simply uses the plurality consensus base call at each position as the base call for the final consensus output sequence. If there is an equal number of base calls (e.g., 5 T's and 5 C's) ties are broken arbitrarily.

The other techniques in this comparison are VS, Clustal+Plurality, and Clustal+HMMER. These techniques perform slightly better than Plurality.

Viswanathan and Swaminathan's technique (VS) is described in Krishnamurthy Viswanathan and Ram Swaminathan. Improved string reconstruction over insertion-deletion channels. In Proceedings of the Nineteenth Annual ACM-SIAM Symposium on Discrete Algorithms (SODA), pages 399-408. Society for Industrial and Applied Mathematics, 2008. VS considers the setting where pₛ<½ and p_{d}, pᵢ=O (1/log (n)), and X is random. VS is a variant of BMA. A position of comparison is maintained for each read. Moreover, each read is either trusted or not at any given time. The reconstruction is done in blocks of length l. At every iteration, a bitwise plurality vote is taken using the trusted reads to determine the next l symbols. The position of comparison is then moved according to the following. For a trusted read, if its look-ahead block of length l has Hamming distance less than δl from the plurality vote, then the position of comparison is moved ahead by l. For a non-trusted read, a window of size rl around the position of comparison is examined to see if there is a block of length l starting there that has Hamming distance less than δl from the plurality vote. If so, then the position of comparison is moved l to the right of this coordinate, and the read is considered to be trusted again. If not, then the position of comparison is increased by l and the read is still not trusted. The end of the sequence is done a bit differently. In short, if there is less than l coordinates left of a read, it becomes non-trusted, and if there are less than 3m/4 trusted reads, then it is assumed that the end of the read is here. Then a simple plurality-like vote determines the last plurality consensus bases. The parameters are chosen in a particular way, l=Θ(log(n)), r=Θ(log(n)).

There are several parameters in VS: l, r, δ, and a parameter the authors arbitrarily set to ¾ referred to here as y. Various combinations of parameter settings were tested to identify which settings provide the best results. The accuracy of VS was highest by letting l be 8, letting r be 2, letting y be 0.5, and letting δ be (0.75+pₛ)/2. These are the parameters used for the VS line in plot 1000.

Clustal is a general-purpose multiple sequence alignment (MSA) tool. In multiple sequence alignment the challenge is in aligning multiple sequences from biological samples. Due to natural genetic variations it is expected that the multiple sequences will have different sequences to varying extents. Thus, this type of analysis is not attempting to identify an original sequence in the presences of noise. Given that the question Clustal is designed to answer is different from the question addressed by the trace reconstruction system, the low probabilities of exact reconstruction are not surprising.

Clustal+Plurality uses Clustal Omega which is the latest and current version of the Clustal program. Clustal Omega is described in Fabian Sievers, Andreas Wilm, David Dineen, Toby J Gibson, Kevin Karplus, Weizhong Li, Rodrigo Lopez, Hamish McWilliam, Michael Remmert, Johannes Riding, Julie D. Thompson, and Desmond G. Higgins. Fast, scalable generation of high-quality protein multiple sequence alignments using Clustal Omega. Molecular Systems Biology, 7(1), 2011. Clustal Omega first computes a distance matrix between the sequences (if there are more than 100 sequences, it first clusters the sequences, and then only fully computes the distant matrix within clusters), from which it creates a guide tree. The sequences are then progressively aligned using the guide tree. That is, first the closest two sequences are aligned, and then one by one all other sequences are aligned as well. Given a MSA, one can then define a consensus sequence by taking the plurality base call at each position. After removing the gaps in the consensus sequence it is possible to obtain an estimate for the original sequence X.

Clustal+HMMER is a different modification of Clustal that uses profile hidden Markov models (HMM). Use of HMM is a different biological application described in Anders Krogh, Michael Brown, I. Saira Mian, Kimmen Sjolander, and David Haussler. Hidden Markov models in computational biology: Applications to protein modeling. Journal of Molecular Biology, 235(5):1501-1531, 1994. Profile HMMs are strongly linear, left-right models, unlike general HMMs. They go from a begin state to an end state, and from left to right there is a sequence of “match” states. Here, match state i emits X[i] with probability (1−p)=(1−pᵢ−pₛ), and it emits a random symbol with the remaining probability. There are also “insert” states and “delete” states: insert states emit a random symbol, while delete states are silent and do not emit anything. The transition probabilities between the underlying states are determined by the probabilities given in the model. Clustal+HMMER was created by adding profile HMMs from the MSAs created by Clustal Omega. These profile HMMs indicate which is the most probable symbol emitted from each match state, so these serve as an estimate \hat{X} of X.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A method comprising:

receiving a plurality of reads from a polynucleotide sequencer, each of the plurality of reads having a respective sequence of base calls;

clustering the plurality of reads into a plurality of clusters by similarity of base call sequences;

selecting a cluster from the plurality of clusters, the cluster containing a clustered set of reads;

aligning the clustered set of reads at a position of comparison spanning the clustered set of reads;

determining a plurality consensus base call at the position of comparison, the plurality consensus base call based at least in part on a most common base call across the clustered set of reads;

identifying a variant read from the clustered set of reads, the variant read having a base call at the position of comparison that is different from the plurality consensus base call;

for a subset of the clustered set of reads having the plurality consensus base call at the position of comparison, identifying a consensus string of base calls in a look-ahead window, the look-ahead window being adjacent to the position of comparison;

determining that an error type for the variant read at the position of comparison is one of substitution, deletion, or insertion based at least in part on the plurality consensus base call and the consensus string of base calls in the look-ahead window, the error type being:
substitution based at least in part on base calls in the look-ahead window of the variant read matching the consensus string of base calls,
deletion based at least in part on a series of base calls in the variant read including the base call at the position of comparison and one or more base calls following the position of comparison matching the consensus string of base calls, or
insertion based at least in part on a base call in the variant read following the position of comparison matching the plurality consensus base call and a series of base calls in the variant read starting two positions following the position of comparison matching the consensus string of base calls;

advancing the position of comparison for the variant read ahead a number of positions based on the error type, the number of positions being one for substitution, zero for deletion, and two for insertion;

advancing the position of comparison for reads in the subset of the clustered set of reads ahead one position; and

determining a single consensus output sequence from the clustered set of reads.

Clause 2. The method of clause 1, wherein at least one of the plurality consensus base call or the error type is determined based at least in part on an error profile associated with the polynucleotide sequencer.

Clause 3. The method of clause 1 or 2, further comprising reversibly randomizing binary data before encoding the binary data in a synthetic polynucleotide strand, the reversibly randomizing performed by taking the exclusive or of the binary data and a random sequence generated by a seed and a function.

Clause 4. The method of clause 1, 2, or 3, further comprising converting the single consensus output sequence into the binary data.

Clause 5. Computer-readable media encoding instructions which when executed by a processing unit cause a computing device to perform the method of any of clauses 1-4.

Clause 6. A system comprising a processing using and memory configured to implement the method of any of clauses 1-4.

Clause 7. A system for error correction of polynucleotide sequencer output comprising:

a processing unit;

a memory;

a sequence data interface configured to receive a plurality of reads from the polynucleotide sequencer;

a read alignment module, stored in the memory and executed on the processing unit, configured to align the plurality of reads at a position of comparison spanning the plurality of reads;

a variant read identification module, stored in the memory and executed on the processing unit, configured to determine a plurality consensus base call at the position of comparison and label a read that has a different base call at the position of comparison as a variant read;

an error classification module, stored in the memory and executed on the processing unit, configured to classify an error type for the variant read as substitution, deletion, or insertion, the classification based at least in part on comparison of a consensus string of base calls in a look-ahead window of a subset of the plurality of reads having the plurality consensus base call at the position of comparison and base calls in the variant read;

wherein the read alignment module advances the position of comparison by one position for reads that have the plurality consensus base call at the position of comparison, by one position for the variant read based at least party on a determination that the error type is classified as substitution, by zero positions for the variant read based at least partly on a determination that the error type is classified as deletion, or by two positions for the variant read based at least partly on a determination that the error type is classified as insertion; and

a consensus output sequence generator, stored in the memory and executed on the processing unit, configured to determine a consensus output sequence, the consensus output sequence based at least in part on the plurality consensus base call and the error type.

Clause 8. The system of clause 7, wherein the plurality consensus base call is based at least in part on an error profile associated with the polynucleotide sequencer.

Clause 9. The system of clause 7 or 8, wherein the error classification module is configured to classify the error type for the variant read as:

substitution upon the consensus string of base calls in the look-ahead window matching a string of base calls in the variant read following the position of comparison,

deletion upon the consensus string of base calls in the look-ahead window matching the base call at the position of comparison in the variant read and one or more following positions, and

insertion upon a base call in the variant read following the position of comparison matching the plurality consensus base call and the consensus string of base calls in the look-ahead window matching a string of base calls in the variant read sequence equal in length to the look-ahead window and starting two positions following the position of comparison.

Clause 10. The system of clause 7, 8, or 9, further comprising a randomization module, stored in the memory and executed on the processing unit, configured to generate pseudo-random strings from binary data to be encoded as a synthetic deoxyribonucleic acid (DNA) strand by taking the exclusive or of the binary data combined with a random string.

Clause 11. The system of clause 7-9 or 10, further comprising a clusterization module, stored in the memory and executed on the processing unit, configured to cluster a subset of the plurality of reads based on likelihoods of the reads being derived from a same DNA strand.

Clause 12. The system of clause 7-10 or 11, further comprising an error-correction module, stored in the memory and executed on the processing unit, configured to decode the consensus output sequence using a non-binary error-correcting code.

Clause 13. The system of clause 7-11 or 12, further comprising a conversion module, stored in the memory and executed on the processing unit, configured to convert the consensus output sequence into binary data representing at least a portion of a digital file.

Clause 14. A polynucleotide sequencer comprising the system of any of clauses 7-13.

Clause 15. A method of correcting errors in sequence data generated by a polynucleotide sequencer, the method comprising:

receiving a plurality of reads classified as representing a polynucleotide strand;

identifying a position of comparison spanning the plurality of reads;

determining a plurality consensus base call at the position of comparison;

identifying a variant read from the plurality of reads that has a base call in the position of comparison that differs from the plurality consensus base call;

determining an error type for the variant read at the position of interest based at least in part on comparison of, for a subset of the plurality of reads having the plurality consensus base call at the position of comparison, a consensus string of base calls in a look-ahead window adjacent to the position of comparison and base calls in the variant read;

advancing the position of comparison for the variant read by a number of positions based on the error type;

advancing the position of comparison one position for the subset of the plurality of reads having the plurality consensus base call at the position of comparison; and

determining a single consensus output sequence based in part on the plurality consensus base call and the error type.

Clause 16. The method of clause 15, wherein the error type for the variant read is determined as being a substitution based on the consensus string of base calls in the look-ahead window being the same as a string of base calls in a look-ahead window following to the position of comparison for the variant read.

Clause 17. The method of clause 15 or 16, wherein the error type for the variant read is determined as being a deletion based on the consensus string of base calls in the look-ahead window being the same as a string of base calls in the variant read including the base call in the position of comparison and adjacent base calls, the string of base calls in the variant read equal in length to the look-ahead window.

Clause 18. The method of clause 15, 16, or 17, wherein the error type for the variant read is determined as being an insertion based on:

a base call in the variant read following the position of comparison being the same as the plurality consensus base call, and

the consensus string of base calls in the look-ahead window being the same as a string of base calls in the variant read sequence equal in length to the look-ahead window and starting two positions following the position of comparison.

Clause 19. The method of clause 15-17 or 18, wherein a length of the look-ahead window is two or three positions.

Clause 20. The method of clause 15-18 or 19, wherein the determining the error type for the variant read at the position of interest is based at least in part on an error profile associated with the polynucleotide sequencer.

Clause 21. The method of clause 15-19 or 20, further comprising reversible randomizing binary data that is encoded as the polynucleotide strands.

Clause 22. The method of clause 15-20 or 21, further comprising clustering the sequence data generated by the polynucleotide sequencer using a clustering technique thereby creating clusters of reads in which the reads of a cluster are determined to be based on a same source DNA strand.

Clause 23. The method of clause 15-21 or 22, further comprising:

determining that the variant read has less than a threshold level of reliability; and

determining the single consensus output sequence from the plurality of reads without using the variant read.

Clause 24. Computer-readable media encoding instructions which when executed by a processing unit cause a computing device to perform the method of any of clauses 15-23.

Clause 25. A system comprising a processing using and memory configured to implement the method of any of clauses 15-23.

### CONCLUSION

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

All publications referenced herein are incorporated by reference both for the specific teachings for which the individual publications are cited and for everything disclosed within the referenced publications.

1-15. (canceled)

16. A method comprising:
receiving a plurality of reads from a polynucleotide sequencer, each of the plurality of reads having a respective sequence of base calls;
clustering the plurality of reads into a plurality of clusters by similarity of base call sequences;
selecting a cluster from the plurality of clusters, the cluster containing a clustered set of reads;
aligning the clustered set of reads at a position of comparison spanning the clustered set of reads;
determining a plurality consensus base call at the position of comparison, the plurality consensus base call based at least in part on a most common base call across the clustered set of reads;
identifying a variant read from the clustered set of reads, the variant read having a base call at the position of comparison that is different from the plurality consensus base call;
for a subset of the clustered set of reads having the plurality consensus base call at the position of comparison, identifying a consensus string of base calls in a look-ahead window, the look-ahead window being adjacent to the position of comparison;
determining that an error type for the variant read at the position of comparison is one of substitution, deletion, or insertion based at least in part on the plurality consensus base call and the consensus string of base calls in the look-ahead window, the error type being:
substitution based at least in part on base calls in the look-ahead window of the variant read matching the consensus string of base calls,
deletion based at least in part on a series of base calls in the variant read including the base call at the position of comparison and one or more base calls following the position of comparison matching the consensus string of base calls, or
insertion based at least in part on a base call in the variant read following the position of comparison matching the plurality consensus base call and a series of base calls in the variant read starting two positions following the position of comparison matching the consensus string of base calls;
advancing the position of comparison for the variant read ahead a number of positions based on the error type, the number of positions being one for substitution, zero for deletion, and two for insertion;
advancing the position of comparison for reads in the subset of the clustered set of reads ahead one position; and
determining a single consensus output sequence from the clustered set of reads.

17. The method of claim 16, wherein at least one of the plurality consensus base call or the error type is determined based at least in part on an error profile associated with the polynucleotide sequencer.

18. The method of claim 16, further comprising reversibly randomizing binary data before encoding the binary data in a synthetic polynucleotide strand, the reversibly randomizing performed by taking the exclusive or of the binary data and a random sequence generated by a seed and a function.

19. The method of claim 16, further comprising converting the single consensus output sequence into the binary data.

20. A system for error correction of polynucleotide sequencer output comprising:
a processing unit;
a memory;
a sequence data interface configured to receive a plurality of reads from the polynucleotide sequencer;
a read alignment module, stored in the memory and executed on the processing unit, configured to align the plurality of reads at a position of comparison spanning the plurality of reads;
a variant read identification module, stored in the memory and executed on the processing unit, configured to determine a plurality consensus base call at the position of comparison and label a read that has a different base call at the position of comparison as a variant read;
an error classification module, stored in the memory and executed on the processing unit, configured to classify an error type for the variant read as substitution, deletion, or insertion, the classification based at least in part on comparison of a consensus string of base calls in a look-ahead window of a subset of the plurality of reads having the plurality consensus base call at the position of comparison and base calls in the variant read;
wherein the read alignment module advances the position of comparison by one position for reads that have the plurality consensus base call at the position of comparison, by one position for the variant read based at least party on a determination that the error type is classified as substitution, by zero positions for the variant read based at least partly on a determination that the error type is classified as deletion, or by two positions for the variant read based at least partly on a determination that the error type is classified as insertion; and
a consensus output sequence generator, stored in the memory and executed on the processing unit, configured to determine a consensus output sequence, the consensus output sequence based at least in part on the plurality consensus base call and the error type.

21. The system of claim 20, wherein the plurality consensus base call is based at least in part on an error profile associated with the polynucleotide sequencer.

22. The system of claim 20, wherein the error classification module is configured to classify the error type for the variant read as:
substitution upon the consensus string of base calls in the look-ahead window matching a string of base calls in the variant read following the position of comparison,
deletion upon the consensus string of base calls in the look-ahead window matching the base call at the position of comparison in the variant read and one or more following positions, and
insertion upon a base call in the variant read following the position of comparison matching the plurality consensus base call and the consensus string of base calls in the look-ahead window matching a string of base calls in the variant read sequence equal in length to the look-ahead window and starting two positions following the position of comparison.

23. The system of claim 20, further comprising a randomization module, stored in the memory and executed on the processing unit, configured to generate pseudo-random strings from binary data to be encoded as a synthetic deoxyribonucleic acid (DNA) strand by taking the exclusive or of the binary data combined with a random string.

24. The system of claim 20, further comprising a clusterization module, stored in the memory and executed on the processing unit, configured to cluster a subset of the plurality of reads based on likelihoods of the reads being derived from a same DNA strand.

25. The system of claim 20, further comprising an error-correction module, stored in the memory and executed on the processing unit, configured to decode the consensus output sequence using a non-binary error-correcting code.

26. The system of claim 20, further comprising a conversion module, stored in the memory and executed on the processing unit, configured to convert the consensus output sequence into binary data representing at least a portion of a digital file.

27. A method of correcting errors in sequence data generated by a polynucleotide sequencer, the method comprising:
receiving a plurality of reads classified as representing a polynucleotide strand;
identifying a position of comparison spanning the plurality of reads;
determining a plurality consensus base call at the position of comparison;
identifying a variant read from the plurality of reads that has a base call in the position of comparison that differs from the plurality consensus base call;
determining an error type for the variant read at the position of interest based at least in part on comparison of, for a subset of the plurality of reads having the plurality consensus base call at the position of comparison, a consensus string of base calls in a look-ahead window adjacent to the position of comparison and base calls in the variant read;
advancing the position of comparison for the variant read by a number of positions based on the error type;
advancing the position of comparison one position for the subset of the plurality of reads having the plurality consensus base call at the position of comparison; and
determining a single consensus output sequence based in part on the plurality consensus base call and the error type.

28. The method of claim 27, wherein the error type for the variant read is determined as being a substitution based on the consensus string of base calls in the look-ahead window being the same as a string of base calls in a look-ahead window following to the position of comparison for the variant read.

29. The method of claim 27, wherein the error type for the variant read is determined as being a deletion based on the consensus string of base calls in the look-ahead window being the same as a string of base calls in the variant read including the base call in the position of comparison and adjacent base calls, the string of base calls in the variant read equal in length to the look-ahead window.

30. The method of claim 27, wherein the error type for the variant read is determined as being an insertion based on:
a base call in the variant read following the position of comparison being the same as the plurality consensus base call, and
the consensus string of base calls in the look-ahead window being the same as a string of base calls in the variant read sequence equal in length to the look-ahead window and starting two positions following the position of comparison.

31. The method of claim 27, wherein a length of the look-ahead window is two or three positions.

32. The method of claim 27, wherein the determining the error type for the variant read at the position of interest is based at least in part on an error profile associated with the polynucleotide sequencer.

33. The method of claim 27, further comprising reversible randomizing binary data that is encoded as the polynucleotide strands.

34. The method of claim 27, further comprising clustering the sequence data generated by the polynucleotide sequencer using a clustering technique thereby creating clusters of reads in which the reads of a cluster are determined to be based on a same source DNA strand.

35. The method of claim 27, further comprising:
determining that the variant read has less than a threshold level of reliability; and
determining the single consensus output sequence from the plurality of reads without using the variant read.
